(19) United States
(12) Patent Application Publication
(10) Pub. No.: US 2016/0346758 A1
(43) Pub. Date: Dec. 1, 2016

(54) SYSTEMS AND METHODS FOR PROCESSING FLUIDS

(71) Applicant: CETAMAX VENTURES LTD., Kowloon (CN)

(72) Inventors: Don Edward Kress, Sudbury Ontario (CA); Kamalul Arifin Yusof, Kajang Selangor (MY)

(21) Appl. No.: 15/170,298

(22) Filed: Jun. 1, 2016

Related U.S. Application Data
(60) Provisional application No. 62/169,345, filed on Jun. 1, 2015.
(60) Provisional application No. 62/180,973, filed on Jun. 17, 2015.
(60) Provisional application No. 62/189,378, filed on Jul. 7, 2015.
(60) Provisional application No. 62/192,214, filed on Jul. 14, 2015.
(60) Provisional application No. 62/218,390, filed on Sep. 14, 2015.
(60) Provisional application No. 62/271,216, filed on Dec. 22, 2015.

(51) Int. Cl. B01J 19/28; B04C 5/08; C01B 3/02; C02F 1/38; C02F 1/46; C10G 31/10; B01F 5/00; B01D 21/26

(52) U.S. Cl. CPC B01J 19/28; B01F 5/0057; B04C 5/08; B01D 21/265; C02F 1/38; C02F 1/4604; C10G 31/10; C01B 3/02; C02F 2101/30

(57) ABSTRACT

A vortex reactor includes a reactor body having first and second ends, with one or more inlet ports coupled to the first end. The reactor is configured to form one or more vortices in a fluid passed into the reactor. The inlet port(s) may be positioned to advance a reactor fluid into the reactor body at an angle tangential to an inner surface of the reactor body, forming a vortex that advances toward the second end along the inner surface of the reactor body. A vortex induction mechanism can be disposed within the reactor to induce or augment a vortex within the reactor. The reactor includes an ultrasound-imparting device configured to generate cavitation bubbles in the reactor fluid. The fluid flow within the reactor concentrates the cavitation bubbles within the vortex, thereby providing beneficial physical and/or chemical effects, while protecting the reactor walls and other reactor components from cavitational erosion.

### CROSS-REFERENCE TO RELATED APPLICATIONS

This application claims the benefit of U.S. Provisional Patent Application No. 62/169,345, filed on Jun. 1, 2015, U.S. Provisional Patent Application No. 62/180,973, filed on Jun. 17, 2015, U.S. Provisional Patent Application No. 62/189,378, filed on Jul. 7, 2015, U.S. Provisional Patent Application No. 62/192,214, filed on Jul. 14, 2015, U.S. Provisional Patent Application No. 62/218,390, filed on Sep. 14, 2015, and U.S. Provisional Patent Application No. 62/271,216, filed on Dec. 22, 2015, the disclosures of which are incorporated herein in their entirety.

### BACKGROUND

The present disclosure relates generally to the processing of one or more fluids by passing the one or more fluids through a reactor. In particular, the present disclosure relates to systems, devices, and methods for processing one or more fluids by passing the one or more fluids through a vortex reactor in order to impart physical and/or chemical effects to the one or more fluids.

One example of a reactor process is acoustic cavitation. Acoustic cavitation of liquids is often desirable in order to initiate or enhance physical and/or chemical activity within the liquid. The formation, growth, and implosive collapse of bubbles in a liquid can result in extreme local conditions (e.g., high temperatures and pressures) at and in the vicinity of the collapsing bubble. These results can lead to increased physical breakdown and/or increased chemical activity or effects.

However, industrial realization of these benefits has been somewhat limited by the absence of scalable reactor and process designs. For example, mixing limitations, mass transfer limitations, heat management, and the inability to form uniform cavitation activity have limited the usefulness of cavitation reactors at practical industrial scales. In addition, cavitation is a significant cause of wear in such reactors. For example, bubble implosion near reactor walls, ultrasonic horns, or other reactor parts leads to rapid wear of the reactor.

### BRIEF SUMMARY

The present disclosure relates to devices, systems, and methods for processing fluids. In some embodiments, a fluid can be passed through a vortex reactor in order to subject the fluid to physical and/or chemical effects. In some embodiments, acoustic energy can be applied to the fluid as it passes through the vortex reactor in order to generate cavitation bubbles to enhance physical and/or chemical effects in the fluid.

In some embodiments, a vortex reactor includes: (1) a reactor body having a first end, a second end, and an inner surface; (2) one or more inlet ports disposed at the first end and configured to direct a fluid at an angle that is substantially tangential to the inner surface of the reactor body; and (3) an outlet. In some embodiments, the outlet is disposed at the second end, and advancing a fluid into the reactor body through the one or more inlet ports causes the fluid to flow in a vortex along the inner surface of the reactor body toward the second end and the outlet.

In some embodiments, the outlet is disposed at the first end, or is disposed between the first end and the second end, and advancing a fluid into the reactor body through the one or more inlet ports causes the fluid to flow in an outer vortex along the inner surface of the reactor body toward the second end before reversing axial/longitudinal direction and flowing toward the outlet in an inner vortex.

In some embodiments, a vortex reactor further comprises an ultrasonic horn extending into the interior of the vortex reactor (or being flush with the reactor or otherwise coupled to the reactor) to impart ultrasonic energy to the contents of the vortex reactor. In some embodiments, a vortex reactor includes one or more tactile sound transducers configured to provide acoustic energy in the audible range to a reactor in order to enable desired effects, such as the disintegration of a waste sludge.

In some embodiments, fluid flow within a reactor can be modulated to increase the residence time of the reactor fluid within a processing zone of the reactor, providing enhanced processing benefits. In some embodiments, a solid object, such as a catalyst and/or mechanical device configured to alter fluid dynamics, can be fixed or suspended within the reactor (e.g., along the longitudinal axis of the reactor) to initiate or enhance processing of the reactor fluid. Other embodiments omit objects, tubes, or other structures within at least the axial region of the reactor so as to allow unimpeded formation and/or flow of the one or more vortices. Similarly, some embodiments that utilize cavitation bubbles are configured to omit inner axial structures so at to enable cavitation bubble concentration near the radial center of the one or more vortices and away from reactor walls and surfaces.

Certain embodiments include a vortex induction mechanism configured to interact with the reactor fluid in order to induce or augment vortical motion of the fluid. In some embodiments, a vortex induction mechanism includes an exterior induction structure disposed along at least a portion of the outer surface of the induction mechanism, and an interior induction structure disposed along at least a portion of an inner conduit of the induction mechanism, and is configured to modulate a first fluid by contacting the exterior induction structure to the first fluid and to modulate a second fluid by passing a second fluid through the inner conduit of the induction mechanism before the first and second fluids are brought together to be mixed.

Embodiments of the present disclosure can provide a number of advantages. For example, fluid flow through the vortex can introduce a negative pressure into the reactor body, promoting the generation of cavitation bubbles for initiating and/or augmenting physical and/or chemical effects within the reactor. In addition, the fluid flow and/or negative pressure can concentrate cavitation bubbles within the interior portions of the vortex and/or in other areas away from reactor walls and other reactor components (e.g., ultrasonic horn), thereby reducing or eliminating cavitation-induced erosion.

Further, because of the induced vortical motion of the reactor fluid within the vortex reactor, cavitation bubbles within the rotating mass of fluid will tend to stay away from the reactor walls while also maintaining relative distances from each other. This promotes an environment of enhanced symmetrical bubble collapse, as opposed to asymmetrical collapse when bubbles are near each other and/or a solid surface and take on a relatively more irregular shape. Symmetrical bubble collapse maximizes the severity of the conditions resulting from the collapse, thereby beneficially enhancing corresponding physical and/or chemical effects to the reactor fluid.

In addition, the intrinsic geometry and fluid flow dynamics of at least some embodiments of the present disclosure provide an opportunity to vary process parameters in order to control the form and consistency of an applied acoustic field, which is important for symmetrical bubble collapse and the corresponding ability to achieve high oxidation efficiency. The oxidation efficiency of an ultrasound reactor depends on many factors such as frequency, power input, acoustic density, liquid temperature, viscosity, as well as reactor geometry and dimensions relative to the horn. Certain embodiments of the present disclosure enable effective optimization of one or more of these factors to thereby provide high levels of oxidation efficiency. Further, mixing and separating applications, among other potential applications, provide beneficial opportunities for manipulation and/or density sorting of matter.

### BRIEF DESCRIPTION OF THE DRAWINGS

To further clarify the above and other advantages and features of the present disclosure, a more particular description of the disclosure will be rendered by reference to specific embodiments thereof which are illustrated in the appended drawings. It is appreciated that these drawings depict only illustrated embodiments of the disclosure and are therefore not to be considered limiting of its scope. Embodiments of the disclosure will be described and explained with additional specificity and detail through the use of the accompanying drawings in which:

FIG. 1A illustrates an embodiment of a single vortex reactor;

FIGS. 1B-1E illustrate various exemplary asymmetric arrangements of inlet ports for a vortex reactor;

FIG. 2 illustrates an embodiment of a dual vortex reactor;

FIG. 3 illustrates an embodiment of a vortex reactor including a vortex induction mechanism;

FIGS. 4A-4D illustrate various embodiments of induction mechanisms;

FIGS. 5A-5C illustrate an embodiment of a vortex reactor including a vortex induction mechanism having separate exterior and interior induction structures;

FIG. 6 illustrates an embodiment of a single vortex reactor including an ultrasonic horn as an energy-imparting device for imparting ultrasound energy to a reactor fluid;

FIG. 7 illustrates an embodiment of a dual vortex reactor including an ultrasonic horn as an energy-imparting device for imparting ultrasound energy to a reactor fluid;

FIG. 8A illustrates an embodiment of a vortex outlet configured with a plurality of concentric sections configured to receive reactor fluid and/or reactor fluid components from separate radial separation zones;

FIG. 8B illustrates an embodiment of a vortex reactor configured for operation in a centrifugation application;

FIGS. 9A and 9B illustrate an embodiment of a single vortex reactor including a solid object within the reactor;

FIG. 10 illustrates an embodiment of a dual vortex reactor including a solid object within the reactor;

FIG. 11 illustrates an embodiment of a vortex reactor with an associated collection tank;

FIG. 12 illustrates an embodiment of a dual reactor with an associated collection tank;

FIG. 13 illustrates an embodiment of a vortex reactor configured for disintegrating a waste stream;

FIG. 14 illustrates an embodiment of a vortex reactor configured for high-efficiency sparging applications;

FIG. 15 illustrates an embodiment of a vortex reactor that may be utilized in a water treatment and/or demulsifying application;

FIGS. 16-17 illustrate embodiments of vortex reactors that may be utilized in a hydrogen generation application; and

FIG. 18 illustrates a hydrogen production process utilizing two or more vortex reactor embodiments.

### DETAILED DESCRIPTION

### I. Introduction

The present disclosure relates to systems, devices, and methods for processing one or more fluids by passing the one or more fluids through a vortex reactor in order to impart physical and/or chemical effects to the one or more fluids.

Some vortex reactor embodiments include a reactor body having a first end and a second end, one or more inlet ports, and one or more outlets, wherein the inlet port(s) and the outlet(s) is/are arranged to enable formation of at least one vortex within the reactor body as reactor fluid is passed into the vortex reactor. As explained in greater detail below, some embodiments are configured to generate a single vortex, and some embodiments are configured to generate multiple (e.g., dual) vortices. In addition, some embodiments include a vortex inducer configured to induce the formation of one or more vortices within the reactor and/or to augment or otherwise adjust the fluid dynamics of the one or more vortices.

One or more embodiments of the disclosure can beneficially reduce or eliminate inadequacies relating to heat management, acoustic field form and consistency, bubble collapse environment, mass transfer, and/or cavitation damage, providing scalable reactor devices, systems, and processes useful in a wide variety of applications. For example, one or more embodiments of the disclosure may be useful for physical breakdown, disintegration, homogenization, and/or mixing of a reactor fluid; initiating and/or enhancing chemical reactivity of a reactor fluid (e.g., increasing cetane number of diesel fuel), for industrial cleaning applications, wastewater treatment (e.g., through the breakdown of organic and/or inorganic pollutants or sludges), waste oil treatment or treatment of other industrial waste fluids, seawater treatment (e.g., for separation of solutes and/or desalination), cell lysing or other biomedical applications, containment of a plasma in a fusion reactor (as in a reactor core or in a reactor core blanket as in a molten salt reactor such as a thorium fission reactor), extraction processes (e.g., extraction of essential oils from plant material), and gradient density centrifugation (e.g., separation of various sized nanomaterials such as carbon nanotubes or graphene flakes).

As used herein, the terms “fluid,” “liquid,” “feed liquid,” “reactor fluid,” and “reactor contents” refer to materials and/or mixtures input into a reactor according to the disclosure in order to be subjected to physical and/or chemical effects imparted by the reactor. Such materials and/or mixtures (e.g., homogeneous or heterogeneous) can include slurries, pastes, sludge, and/or liquids, and may include suspended solids and/or dissolved gases. Such materials and/or mixtures can also include gases, gas mixtures, liquid and gas mixtures, and gas and plasma mixtures, particularly in conditions wherein the aforementioned behave as liquids. In some embodiments, a reactor fluid is or behaves as a non-compressible liquid.

As used herein, the terms “disintegration,” “disintegrate,” “disintegrating,” and the like refer to the physical breakdown of at least some components of a treated stream of material, leading to a decrease in average particle size, narrower particle size distribution, and/or increase in uniformity of particle size.

As used herein, the terms “ultrasound,” “ultrasonic,” and the like refer to levels of acoustic energy having a frequency, or being within a frequency range, that is above the upper limit of human hearing of about 20 kHz. As used herein, the terms “audible sound,” “audible acoustic energy,” and the like refer to levels of acoustic energy having a frequency or being within a frequency range that is at or below the upper limit of human hearing of about 20 kHz and at or above the lower limit of human hearing of about 20 Hz. As used herein, the terms “sub-audible sound,” “sub-audible acoustic energy,” and the like refer to levels of acoustic energy having a frequency or being within a frequency range that is below the lower limit of human hearing of about 20 Hz.

Some embodiments include one or more energy-imparting devices configured to impart energy to a reactor fluid in order to, for example, initiate and/or augment physical effects (e.g., mixing, heating, disrupting, disintegrating) and/or chemical effects (e.g., free radical formation, bond formation and/or breaking) in the reactor fluid or components thereof. Some embodiments include an ultrasonic horn or other device for imparting ultrasound energy. Some embodiments include one or more tactile sound transducers for imparting audible sound energy. Other embodiments may include additional or alternative energy-imparting devices, such as lasers, microwave generators, other electromagnetic energy generators, and/or magnetic field generators for use in a mixing, separating, heating, cooling, and/or containment (e.g., plasma containment) process.

Reactors according to the disclosure may include one or more ultrasonic actuators (e.g., an ultrasound transducer and/or ultrasonic horn) configured to form cavitation bubbles within the feed liquid of a reactor (e.g., as in a sonochemical reactor). Microscopic gas bubbles present in a liquid can be forced to oscillate due to the alternating low and high pressure waves of the applied acoustic field. If the acoustic intensity is sufficiently high, the bubbles may grow to a threshold size before rapidly collapsing, leading to the formation of extreme local conditions and possibly secondary effects, including emission of light and/or acoustic energy, formation of free radicals, and potential surface erosion of nearby surfaces (e.g., nearby reactor walls, an ultrasonic horn, and/or other reactor equipment).

In other embodiments, cavitation bubbles may be formed, alternatively or additionally, through other means, such as by optic cavitation (e.g., laser pulse), particle cavitation (e.g., by proton or neutrino pulses), electrical discharge, oscillating magnetic field, hydrodynamic flow of liquid components, a spinning rotor capable of creating mechanical cavitation, and combinations of the foregoing.

Though many of the embodiments described herein include sonochemical reactor configurations, such as an ultrasonic horn, other means of cavitation bubble formation may be utilized as an alternative to, or in addition to, such a sonochemical reactor configuration.

### II. Vortex Reactor Configurations

A. Single Vortex Reactors

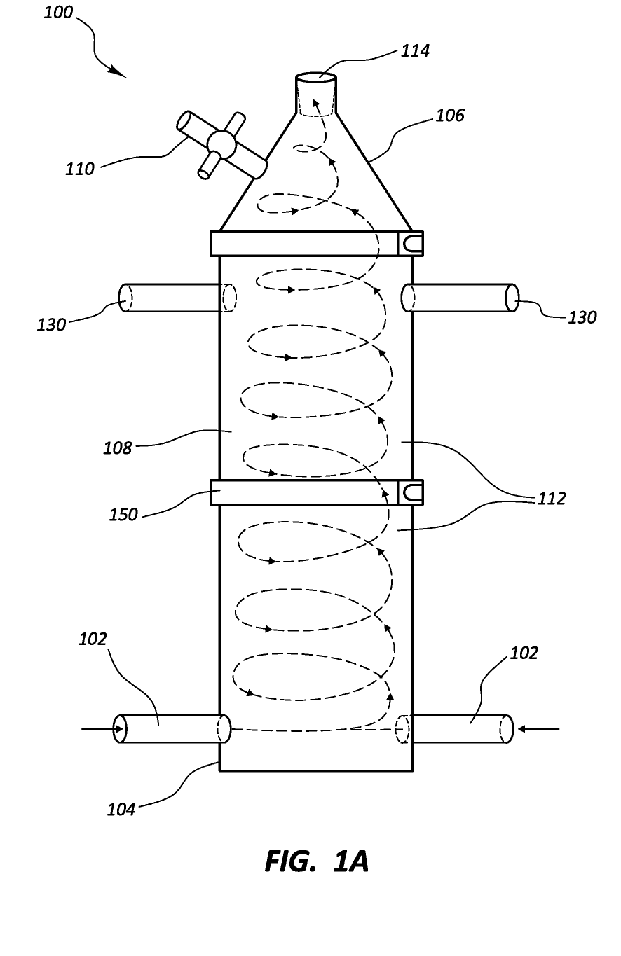

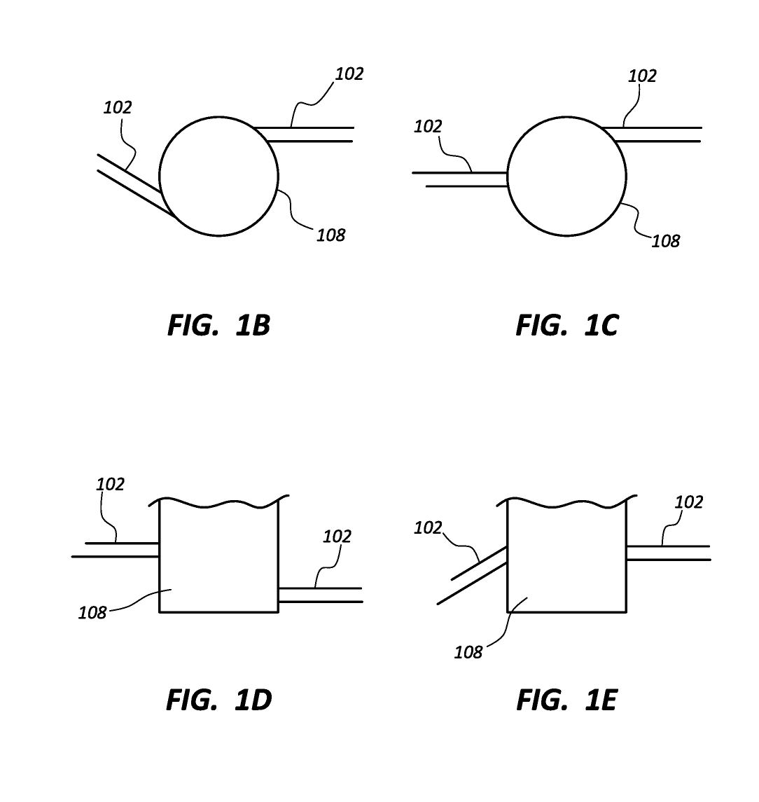

FIG. 1A illustrates an embodiment of a vortex reactor 100 configured to form a single vortex during operation of the reactor (e.g., when one or more fluids are passed into the reactor). The illustrated embodiment includes one or more inlet ports 102 disposed at a first end 104 of vortex reactor 100. Inlet ports 102 can open into a reactor body 108 configured to house a reactor fluid transferred into vortex reactor 100. In the illustrated embodiment, reactor body 108 has a circular cross-section. In other embodiments, the reactor body can have a conical shape such that a diameter at a second end 106 is wider than a diameter at a first end 104, or can have a cylindrical, triangular, square, rectangular, or other polygonal shaped cross-section, or have an ellipsoid or ovoid cross-section. Additionally, or alternatively, other embodiments may include a wider diameter at first end 104 relative to a diameter at second end 106, or may have a diameter at first end 104 that substantially equals a diameter of second end 106. In other embodiments, reactor body 108 may have a barbell shape or other shape of differing cross-section shape and/or diameter along the length of reactor body 108.

In some embodiments, a reactor body is formed with an egg shape or reverse egg shape (e.g., upside down egg shape having a wider portion at a second end). In some embodiments, a reactor body is formed to provide a curved, spiraled, and/or helical path within the interior of the reactor body.

As illustrated, inlet ports 102 are oriented so as to receive a reactor fluid at an angle that is tangential, or substantially tangential to an inner surface of reactor body 108. Such configuration allows the fluid to form a vortex as it advances into reactor body 108. The vortex can cause the fluid within the reactor to be subjected to centripetal and/or centrifugal forces along the trajectory of the vortex. Additionally, or alternatively, reactor 100 can include a pump, turbine and/or impeller assembly, or other fluid movement means configured to form and/or strengthen the vortex, such as the vortex inducer described below. Inlet ports 102 and/or other fluid movement means can be configured to provide vortex rotation in either direction (e.g., clockwise or counterclockwise from the perspective of a given end of the reactor).

The illustrated embodiment includes a pair of inlet ports 102 disposed at first end 104 of reactor 100. Other embodiments may include one inlet port or may include two or more inlet ports. In the illustrated embodiment, first end 104 and inlet ports 102 are disposed at the bottom of a vertically oriented reactor body 108, and the resulting vortex can operate as an upflow vortex. In other embodiments, one or more inlet ports may be disposed on an upper end of a vertically oriented reactor body, allowing for a downflow vortex during operation. In yet other embodiments, a reactor body may be oriented horizontally, or diagonally, and one or more inlet ports can be configured to provide a horizontally or diagonally moving vortex.

As shown, one or more inlet ports 102 can be configured to deliver a reactor fluid at an angle that is tangential to reactor body 108. In addition, one or more inlet ports can be configured to deliver a reactor fluid at an upward angle or downward angle (e.g., an angle opening toward second end 106 or toward first end 102). The angle at which an inlet port is directed can be adjusted to provide one or more desired features to fluid flow within reactor 100. For example, relatively higher angles can provide a vortex that has a lower angular velocity. On the other hand, relatively lower angles can provide a vortex that has a higher angular velocity. Such angles can advantageously alter the fluid dynamics within the reactor to provide desired pressures, mixing effect, and/or other flow dynamics.

In some embodiments, inlet ports 102 are angled substantially perpendicular to a longitudinal axis of reactor 100 (e.g., not angled toward second end 106). Such embodiments may provide a vortex that rotates along the inner surface of reactor body 108 for a longer period of time and/or moves toward second end 106 more slowly relative to embodiments where one or more inlet ports 102 are angled toward second end 106. In other embodiments, one or more inlet ports 102 are angled toward second end 106 (as measured from a position perpendicular to the longitudinal axis) at up to about 85 degrees. For example, one or more inlet ports 102 may be angled toward the second end 106 at about 5, 15, 25, 35, 45, 55, 65, 75, or 85 degrees, or ranges between two of these values, or integer value between these specified values.

In embodiments where a plurality of inlet ports 102 are included, the tangentially arranged inlet ports 102 are preferably asymmetrically aligned with at least one other inlet port so as to provide beneficial mixing of inflowing reactor fluid in at least the initial flow region of the reactor 100. Such asymmetrical alignment provides a more turbulent initial flow, allowing advantageous mixing to occur in at least the initial flow region (e.g., region near the inlet ports 102) of the reactor 100. Then, as the reactor fluid continues to flow toward the outlet 114, the fluid will self-organize into a relatively more structured vortical flow beneficial for separation or other processes. In contrast, reactor configurations where inlet ports are completely aligned tend to induce laminar flow even in the initial flow regions of the reactor, limiting the mixing potential of those initial flow regions.

FIGS. 1B-1E illustrate exemplary inlet port arrangements showing various configurations of asymmetrical alignment. FIG. 1B illustrates a cross-sectional view of a reactor body 108 showing a pair of asymmetrically arranged inlet ports 102. As shown, the axis of a first inlet port is transverse to the axis of a second inlet port, even while the inlet ports 102 are substantially tangentially arranged with respect to the wall of the reactor body 108. Other embodiments including more than two inlet ports may be similarly configured such that at least one inlet port has an axis that is out of alignment with at least one other inlet port.

FIG. 1C illustrates another configuration where, although the axes of the inlet ports 102 are substantially parallel, an asymmetrical relationship is provided by the unequal radial offset of the inlet ports 102 around the circumference of the reactor body 108. For example, where an aligned configuration will circumferentially space two separate inlet ports by 180 degrees, the illustrated inlet ports may be spaced by some other unequal/unbalanced circumferential spacing, such that the distance between a first inlet port and a second inlet port in a first circumferential direction is different than the distance between the first inlet port and the second inlet port in a second circumferential direction. Embodiments having more than two inlet ports may be similarly configured. For example, an embodiment having three inlet ports may be configured such that the inlet ports avoid a spacing where each inlet port is 120 degrees apart from each neighboring inlet port.

FIG. 1D illustrates a front view of another asymmetrical inlet port arrangement. As shown, even though the inlet ports 102 may have axes that are substantially parallel with respect to a cross-sectional view, the inlet ports 102 are positioned such that one of the inlet ports is out of planar alignment with the other inlet port (e.g., the inlet ports 102 are vertically offset). Embodiments having more than two inlet ports may be similarly configured so that at least one of the inlet ports is out of planar alignment with at least one other inlet port.

FIG. 1E illustrates a front view of another asymmetrical inlet port arrangement. As with the arrangement shown in FIG. 1B, the arrangement shown in FIG. 1E includes a first inlet port having an axis that is transverse to a second inlet port. Where the arrangement shown in FIG. 1B illustrates asymmetrical alignment based on transverse axes with respect to a cross-sectional plane, the arrangement shown in FIG. 1E illustrates asymmetrical alignment based on transverse axes with respect to a front-view plane.

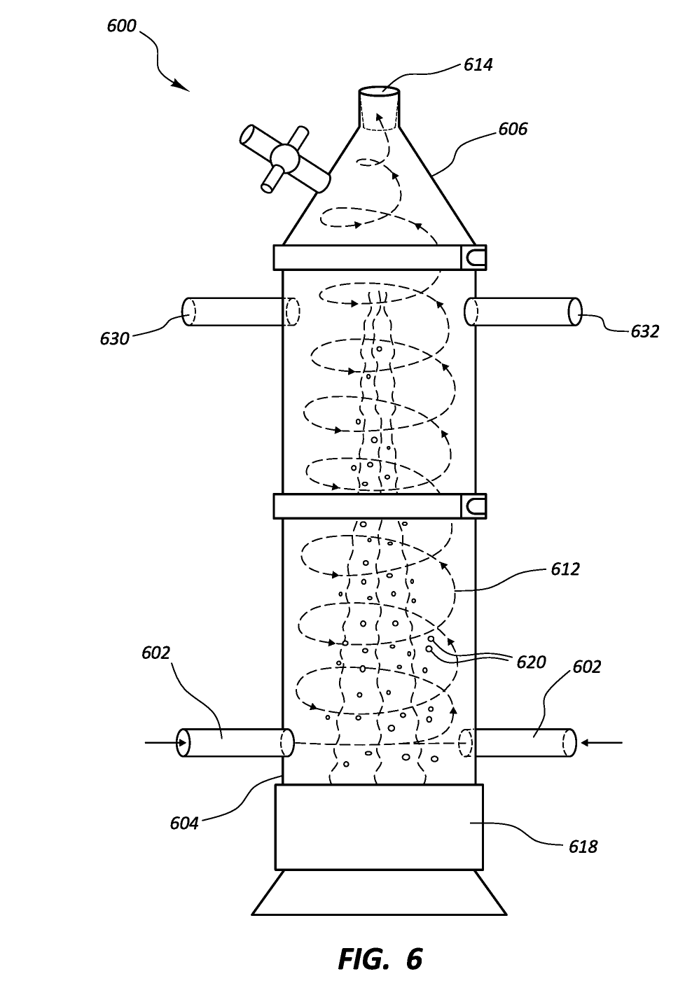

Referring back to FIG. 1A, vortex reactor 100 can include a bleed opening 110 disposed at or near second end 106 of the reactor. In other embodiments, bleed opening 110 can be disposed at or near first end 104 (e.g., in downflow embodiments such as in FIG. 6). In the illustrated embodiment, bleed opening 110 is configured to bleed off air or other gases and/or liquids that may be present in reactor body 108 prior to advancing a reactor fluid into reactor 100. Bleed opening 110 may be formed as a hole, slit, valve, or other opening. In some embodiments, a bleed opening is configured as a valve, such as a one-way valve allowing the passage of air or other gas out of the reactor but not into the reactor (or vice versa). In some embodiments, a bleed opening is configured as a valve allowing the passage of air or other gas out of the reactor but preventing the passage of liquid out of the reactor. In some embodiments, a bleed opening includes an attachment and/or fitting configured to allow a hose, gas line, or other attachment to be coupled to the reactor.

In some embodiments, bleed openings may be omitted. In some embodiments, one or more bleed openings are disposed at first end 104 of reactor 100. For example, one or more bleed openings may be disposed at first end 104 of the reactor in embodiments having a downflow configuration, or having a horizontal or diagonal configuration.

Illustrated reactor 100 includes a vortex outlet 114 disposed at second end 106 of reactor 100 and/or extending from second end 106. In some embodiments, vortex outlet 114 extends from second end 106 a distance into reactor body 108 (e.g., as a pipe or conduit extending into reactor body 108). In the illustrated embodiment, vortex outlet 114 is disposed along a central axis of reactor 100 at an end of the reactor opposite inlet ports 102.

In some embodiments, vortex outlet 114 can be configured to be adjustable so as to provide for reconfiguration of vortex dynamics during operation of the reactor. For example, a vortex outlet can be configured to be manually repositionable within a reactor body. In some embodiments, a vortex outlet can be configured to automatically follow a selected path within the reactor body. For example, a vortex outlet 114 can be configured to be raised or lowered (e.g., to change the distance to which it extends within the reactor) during operation. Alternatively, a vortex outlet 114 can be configured to follow a pre-defined movement pattern.

In some embodiments, the reactor omits internal baffles and/or other mechanical obstructing structures, allowing fluid flow through the reactor to self-organize into a vortex configuration. In some embodiments, a reactor can include one or more matter inlets configured to receive injectable matter (e.g., solid, liquid, gas, plasma) into the reactor. For example, in some embodiments, a matter inlet can be disposed at first end 104 of the reactor (e.g., near inlet ports 102), allowing matter to be injected into the reactor at or near the area where the vortex initially forms.

The illustrated vortex reactor 100 may be configured as a modular or sectional structure. As shown, vortex reactor 100 may be assembled from one or more modular sections 112 that are coupled together (e.g., by a coupling 150) to form a reactor with desired design characteristics. For example, adjacent modular sections 112 may be formed with the same or similar cross-sectional dimensions, and a number of sections can be connected or joined in series in order to adjust the length to diameter ratio (L/D ratio) of the assembled reactor to a desired value. In other embodiments, different modular sections have different cross-sectional dimensions and/or different lengths, and a combination of such different modular sections can be coupled in order to provide an assembled reactor with desired structural characteristics, such as a progressively widening or narrowing diameter, alternating diameter, etc.

Illustrated reactor 100 also includes a set of wall ports 130 near second end 106 that can function as outlet ports for conducting the reactor fluid out of the reactor, or alternatively may be plugged or otherwise closed.

B. Dual Vortex Reactors

Some embodiments are configured to provide multiple (e.g., dual) vortices within the reactor during operation. Embodiments of dual vortex reactors can be similar to embodiments of single vortex reactors in many respects. For example, the description relating to embodiments of single vortex reactors may be applied to the description relating to embodiments of dual vortex reactors with respect to reactor body cross-section and shape, the number and orientation/angle of inlet ports, reactor orientation, bleed opening functionality and configuration, vortex outlet adjustability, matter inlets, and/or other components not specified as distinguishing between single vortex and dual vortex reactor embodiments.

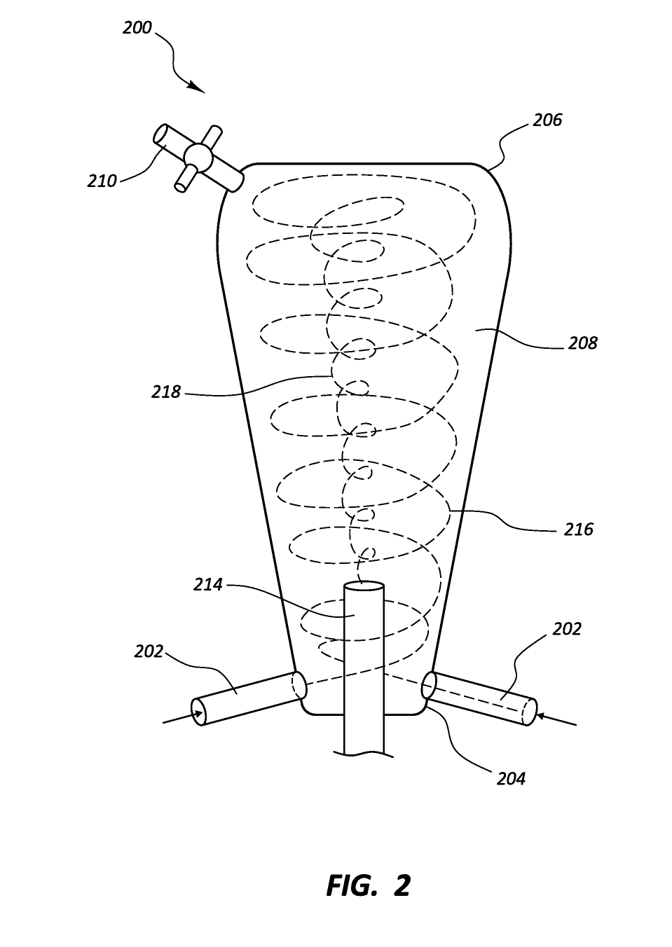

FIG. 2 illustrates an embodiment of a dual vortex reactor 200. The illustrated embodiment includes one or more inlet ports 202 disposed at first end 204 of reactor 200. Inlet ports 202 can open into a reactor body 208 configured to house a reactor fluid transferred into the vortex reactor 200. In the illustrated embodiment, inlet ports 202 are oriented so as to receive a reactor fluid at an angle that is tangential, or substantially tangential, to an inner surface of reactor body 208. This configuration allows the fluid to form an outer vortex 216 as it advances into reactor body 208. Outer vortex 216 subjects the fluid within the reactor to centripetal and/or centrifugal forces along the trajectory of outer vortex 216. Inlet ports 202 and/or other fluid movement means can be configured to provide vortex rotation in either direction (e.g., clockwise or counterclockwise from the perspective of a given end of the reactor).

Illustrated reactor 200 includes a bleed opening 210 disposed at second end 206 of reactor 200 and a vortex outlet 214 disposed at first end 204 of the reactor. In the illustrated embodiment, vortex outlet 214 extends from first end 204 a distance into reactor body 208. Illustrated vortex outlet 214 is disposed along a central axis of reactor 200, and inlet ports 202 are arranged in a radial pattern around vortex outlet 214. The size, shape, and/or features of reactor 200 allow a reactor fluid to self-organize into an outer vortex 216 advancing toward second end 206, before the fluid reverses axial/longitudinal direction to travel back down to first end 204 in an inner vortex 218 as it advances toward vortex outlet 214.

In some embodiments, the rotation direction of outer vortex 216 and the rotation direction of inner vortex 218 are the same, such that outer vortex 216 and inner vortex 218 co-rotate in the same direction. In some embodiments, the resulting fluid flow results in a dual vortex configuration, with the vortices being co-rotational along a common axis in a longitudinally countercurrent fashion. In some embodiments, the reactor can omit baffles and other mechanical obstructing structures, allowing fluid flow through the reactor to self-organize into a dual vortex configuration. Other embodiments include objects, energy-imparting devices, and/or vortex induction mechanisms configured to augment, or adjust one or more of the vortices and/or to provide other beneficial functions.

In other embodiments, as outer vortex 216 advances along the inner surface of reactor body 208 and toward second end 206, the fluid can be induced to reverse rotation at the second end and be directed into an inner vortex 218 that advances toward vortex outlet 214. Inner vortex 312 thus can counter-rotate and flow along the axis countercurrent to outer vortex 316, creating a high shear interface between outer vortex 316 and inner vortex 312. Embodiments including counter-rotating vortices can be advantageous in high shear applications by providing high shear at the interface between the vortices.

In some embodiments, reactor 200 can be configured to provide fluid flow that minimizes fluid exit through bleed opening 210. For example, reactor 200 can be configured such that 60% or more, 70% or more, 80% or more, 90% or more, 95% or more, or 99% or more of the fluid flow exits the reactor through vortex outlet 214 (as opposed to, e.g., bleed opening 210).

In some embodiments, a reactor includes a vortex sheath, shaped as a hyperbolic cone and/or perforated structure positioned at the junction of the outer and inner vortex, configured to allow and/or augment the ability of an inner vortex to counter-rotate relative to an outer vortex (e.g., by preventing disruption of the vortices by turbulent and chaotic flow patterns). In some embodiments, the inner vortex can form a hyperbolic cone shape. Additionally, or alternatively, parameters of the reactor can be configured to provide an inner vortex having a hexagonal cross-section.

Embodiments described herein can provide a number of benefits. For example, the vortices can subject a reactor fluid to an array of centrifugal and centripetal forces within a single reactor. In some circumstances, components of the reactor fluid can be mixed by passing the fluid through the reactor (e.g., by mixing along the interface between the outer vortex and inner vortex or portion thereof). In some circumstances, components of the reactor fluid can be separated by passing the fluid through the reactor (e.g., by relatively heavier solids and/or liquids concentrating in the outer vortex where centrifugal forces are relatively high, and relatively lighter solids and/or liquids passing to the inner vortex where centrifugal forces are relatively low). For example, some embodiments may include a heavy phase outlet disposed in the reactor wall (e.g., at or near its widest diameter) configured to provide collection of a heavy phase and/or solids phase from the reactor fluid, while a lighter phase passes to the inner vortex.

C. Vortex Induction Mechanism

As described above, some embodiments are configured to induce one or more vortices through a relationship between the one or more inlet ports and the reactor body. Additionally, or alternatively, a vortex reactor may include one or more pumps, turbines, impellers, and/or other fluid movement means configured to form and/or strengthen the one or more vortices within the reactor. Such fluid movement means can also impart a desired pressure within the reactor. The fluid movement means can be configured to cause the vortex to rotate in either direction (e.g., clockwise or counterclockwise from the perspective of a given end of the reactor). For example, in some embodiments, one or more pumps can be used to push and/or draw fluid into and out of the reactor.

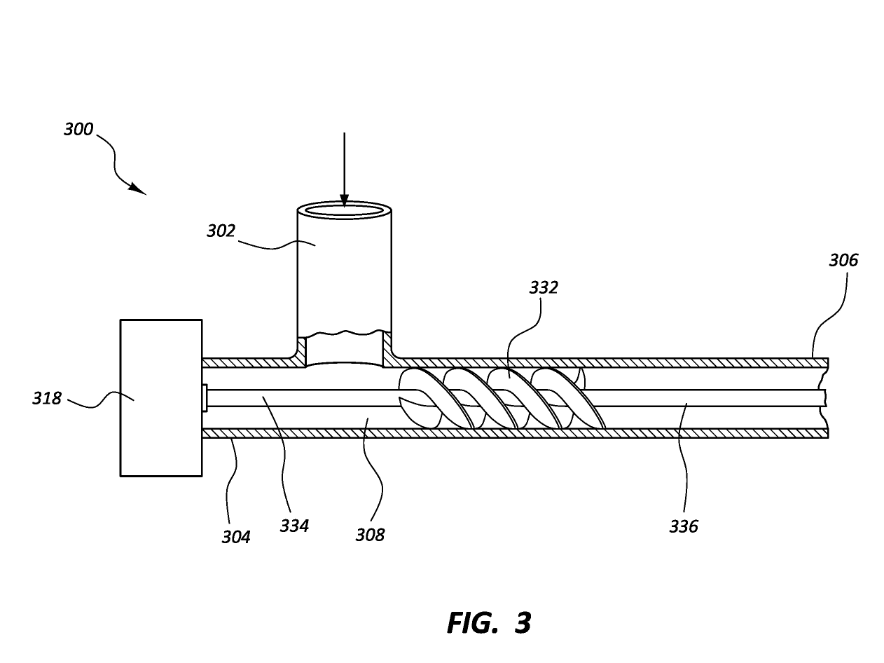

Some embodiments include a vortex induction mechanism configured to form or augment one or more vortices within the reactor. FIG. 3 illustrates an embodiment of a reactor 300 having a reactor body 308, an inlet port 302 for conducting a reactor fluid into reactor body 308, and an induction mechanism 332 positioned within reactor body 308 and configured to contact reactor fluid to induce vortical motion in the reactor fluid as it passes through induction mechanism 332.

In the illustrated embodiment, inlet port 302 is disposed so as to deliver a reactor fluid into reactor body 308 upstream from induction mechanism 332 (i.e., deliver a reactor fluid at a point between first end 304 and induction mechanism 332). Induction mechanism 332 is preferably disposed along a longitudinal length of reactor body 308 sufficient to induce a desired level of vortical motion in the reactor fluid before the reactor fluid passes to areas within the reactor downstream from induction mechanism 332. For example, as shown in the illustrated embodiment, induction mechanism 332 may be disposed along approximately 20-40% of the longitudinal length of reactor body 308. In other embodiments, an induction mechanism may have a length of about 5, 10, 25, 50, 75, or 90% of the length of the reactor body 308, or may have a length within a range of two of those values, or other integer values between these values.

The illustrated embodiment also includes an energy-imparting device 318. In this example, energy-imparting device 318 is configured as an ultrasound transducer with an axial probe extending from first end 304 into reactor body 308. As shown, the axial probe may have a non-emitting section 334 disposed at or near first end 304 and extending toward second end 306. In the illustrated embodiment, induction mechanism 332 includes a central bore through which the probe may be passed. In the illustrated configuration, the probe is passed through the bore of induction mechanism 332 such that an emitting section 336 of the probe is positioned downstream of induction mechanism 332 (i.e., is at least partly positioned between induction mechanism 332 and second end 306).

The illustrated embodiment enables a reactor fluid to be subjected to beneficial physical and/or chemical effects. For example, a reactor fluid may be passed into reactor body 308 through inlet port 302, where it is contacted with induction mechanism 332. As pressure drives the fluid through induction mechanism 332 and toward second end 306, the geometric configuration of induction mechanism 332 causes or augments vortical flow within the reactor fluid. As reactor fluid passes beyond induction mechanism 332, it enters a section of reactor body 308 in which emitting section 336 of the probe can impart ultrasound energy (and/or other types of energy described herein) to the vortically flowing reactor fluid.

Induction mechanism 332 may be configured according to various operational parameters (e.g., fluid flow rate, fluid pressure, size and shape of reactor body, size and shape of energy-imparting device, type of energy imparting device, type of fluid, etc.) to provide a desired level of vortical flow to the reactor fluid passing beyond induction mechanism 332 and into the reaction zone of the reactor (e.g., the zone where reactor fluid is exposed to emitting section 336 of the probe).

In some embodiments, an induction mechanism has a cross-sectional diameter that is substantially equal to the inner diameter of a reactor body. In other embodiments, an induction mechanism has a cross-sectional diameter of about 50, 60, 70, 80, 90, 95, or 99%, or ranges between two of these values, of the inner diameter of a reactor body.

An induction mechanism may be positioned at various locations within a reactor body. For example, in some embodiments, an induction mechanism is positioned at or near a first end in the vicinity of one or more inlet ports. In other embodiments, an induction mechanism is positioned so as to leave a space between the induction mechanism and the one or more inlet ports.

Although the embodiment shown in FIG. 3 includes an axial ultrasound probe, other embodiments may include one or more energy-imparting devices disposed at different locations of a reactor and/or one or more different types of energy-imparting devices. For example, some embodiments include one or more energy-imparting devices disposed along a wall of the reactor body (e.g., and passing through the wall into the interior of the reactor body) and/or near the second end of the reactor.

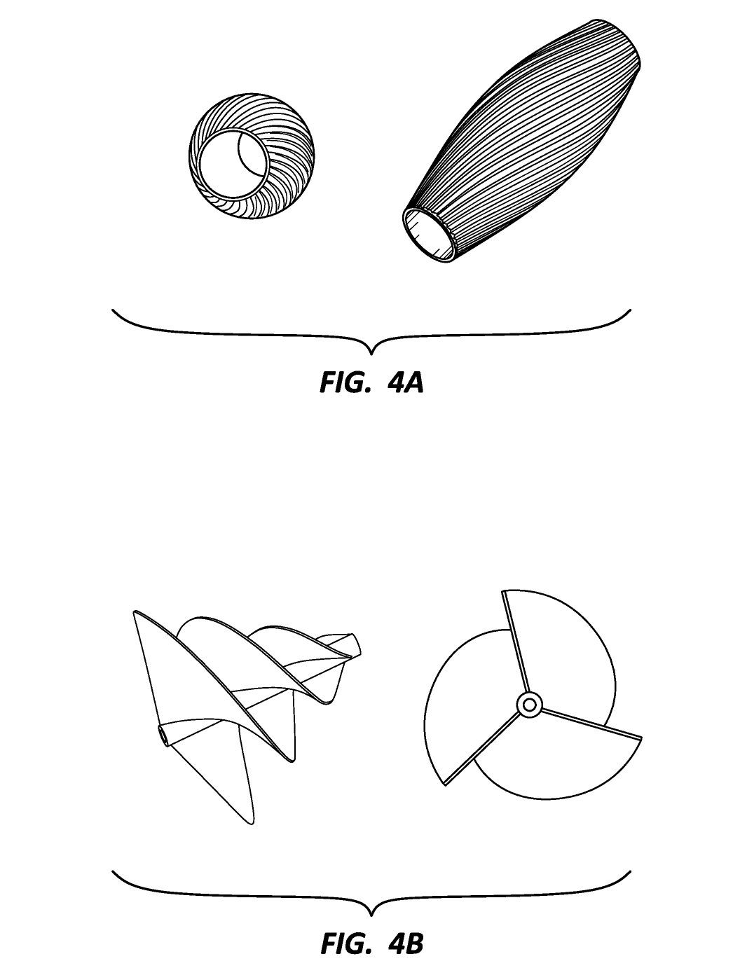

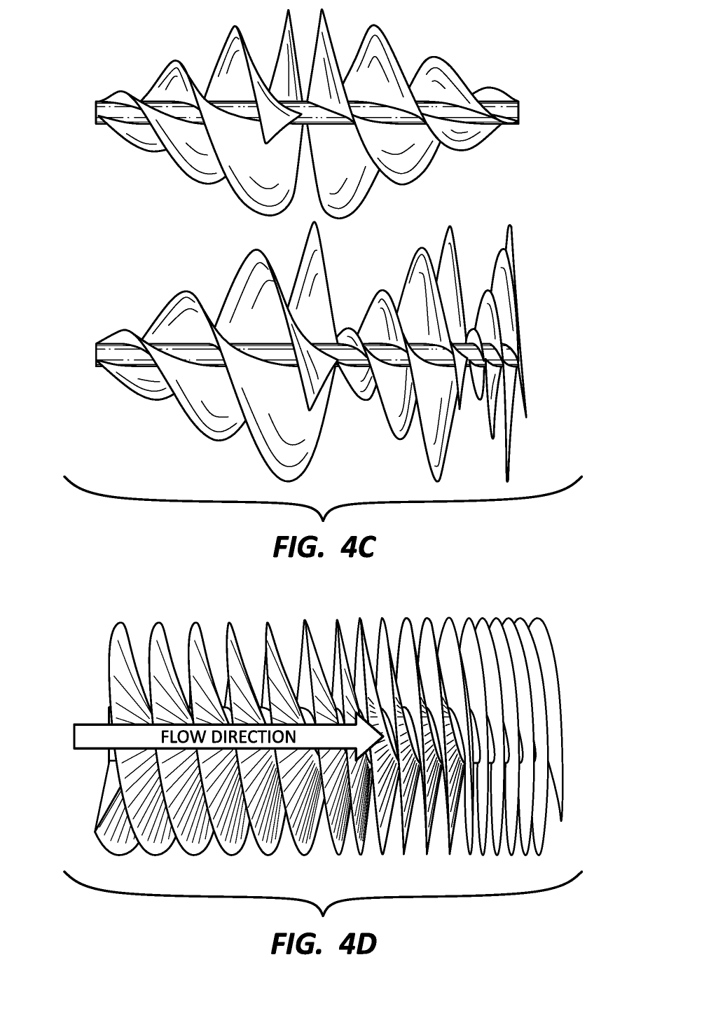

FIGS. 4A-4D illustrate various embodiments of induction mechanisms suitable for inducing or augmenting vortical flow within a vortex reactor. As shown, an induction mechanism may be configured with variable size and number of flights and grooves, variable rotation direction (clockwise or counterclockwise), and variable bore size (e.g., configured to fit a given probe). The flights may have variable pitch, angle, major diameter, minor diameter, and pitch diameter.

The embodiment illustrated in FIG. 4A is shaped as prolate spheroids. The embodiment illustrated in FIG. 4B is shaped as a helix with flights of continuously decreasing or continuously increasing (depending on orientation) diameter. Such embodiments may beneficially provide desired vortical flows by allowing for an increasingly narrower or increasingly wider gap between the inner surface of a reactor wall and the induction mechanism from the perspective of a reactor fluid as the reactor fluid flows past the induction mechanism.

FIG. 4C illustrates a combination of induction mechanisms arranged in series to provide desired effects. In one example, under sufficient fluid flow, an induction mechanism having the proper geometry could enable hydrodynamic cavitation within a passing reactor fluid. In some embodiments, this hydrodynamic cavitation effect is combined with an ultrasound acoustic field to further augment the creation of cavitation events and accompanying physical and/or chemical effects.

Other induction mechanisms may have intertwined and/or overlying flight spirals. Such embodiments may include several (e.g., 2, 3, 4, 5 or more) separate pitch values on one integral induction mechanism. In some embodiments, the intertwined and/or overlying flight spirals may be configured to induce changes to pressure and/or velocity of fluid flow in order to enable desired fluid dynamics.

FIG. 4D illustrates an embodiment of an induction mechanism having varying pitch in order to accelerate the angular velocity of a fluid as it moves forward through the induction mechanism. Such embodiments can enable a gradual increase in angular velocity of a reactor fluid from a level upstream from the induction mechanism to a desired level upon exiting the induction mechanism.

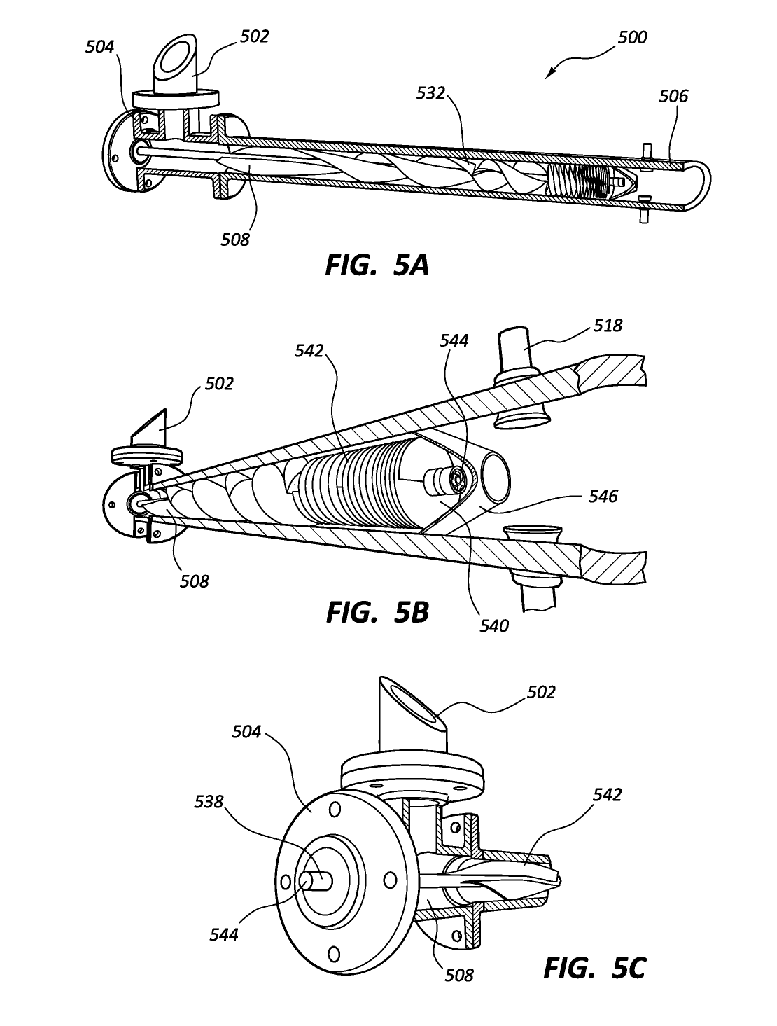

FIGS. 5A-5C illustrate different views of an embodiment of a reactor 500 including a first inlet port 502 located near a first end 504 (proximal end), a second inlet port 538 located near first end 504, a reactor body 508, and an induction mechanism 532 extending toward a second end 506 (distal end) from a point at or near first end 504. In the illustrated embodiment, induction mechanism 532 is configured with an exterior induction structure 542 disposed along at least a portion of the outer surface of the induction mechanism and an interior induction structure 544 disposed along at least a portion of the inner surface of the induction mechanism within an interior channel of the induction mechanism (seen in FIGS. 5B and 5C). As shown, a first fluid may be passed into reactor 500 through first inlet port 502, and a second fluid may be passed into reactor 500 through second inlet port 538. The first and second fluids then continue to pass toward second end 506.

As shown, the first fluid may be passed into reactor body 508, where contact with the exterior induction structure 542 induces or augments a first vortical flow within the first fluid. In addition, the second fluid may be passed into the interior channel of induction mechanism 532, where contact with interior induction structure 544 induces or augments a second vortical flow within the second fluid.

In some embodiments, the vortical flow of the first fluid and the vortical flow of the second fluid have similar fluid dynamics (e.g., similar angular velocity, linear velocity, pressure, etc.). In other embodiments, the vortical flows of the first and second fluids exhibit different fluid dynamics. For example, exterior induction structure 542 and interior induction structure 544 may be independently configured to provide desired vortical flows for the first fluid and the second fluid, respectively.

The first and second fluids pass through their respective sections of induction mechanism 532 until arriving at a mixing zone 540 located distally from induction mechanism 532. This mixing zone 540 can beneficially introduce the first and second fluids with high rates of shear mixing. In preferred embodiments, the first fluid and the second fluid are induced to rotate in opposite directions to increase shear mixing in mixing zone 540.

In some embodiments, the first fluid and the second fluid are different fluids, such as separate fluids that are beneficially mixed together through operation of reactor 500. In other embodiments, the first fluid and the second fluid are the same, and operation of reactor 500 can augment the degree of mixing within the fluid and/or can further cause other desired physical and/or chemical effects. In some embodiments, the first and/or second fluids are disposed to the mixing zone through an opening sized such that hydrodynamic cavitation is induced. For example, an exit velocity of >20 m/s may be necessary in some fluids to induce hydrodynamic cavitation.

The illustrated embodiment includes an energy-imparting device 518 disposed so as to impart energy into reactor body 508 at or near mixing zone 540. As shown, energy-imparting device 518 may be disposed radially around reactor body 508 near mixing zone 540. Energy-imparting device 518 may be any type of energy-imparting device as described herein. In some embodiments, energy-imparting device 518 can be an ultrasound transducer configured to deliver ultrasound energy to the one or more fluids in mixing zone 540.

Embodiments such as those illustrated in FIGS. 5A-5C enable high rates of mixing and shear forces within one or more fluids. In addition, the ability to impart energy to the one or more fluids at a fluid mixing zone, where intense levels of mixing are occurring, enables the efficient introduction of desired physical and/or chemical effects to the mixing fluid(s).

### III. Exemplary Applications

One or more embodiments described herein may be used in for sonication, mixing, separating, purifying, desalinating, disintegrating waste, and/or other applications imparting physical and/or chemical effects to a reactor fluid. Although the following descriptions may describe certain exemplary reactor configurations in relation to certain applications, it should be recognized that the described reactor configurations may be used for other applications, and other reactor configurations, apart from those particularly described for a given application, may be utilized in the given application.

A. Energy-Imparting Devices

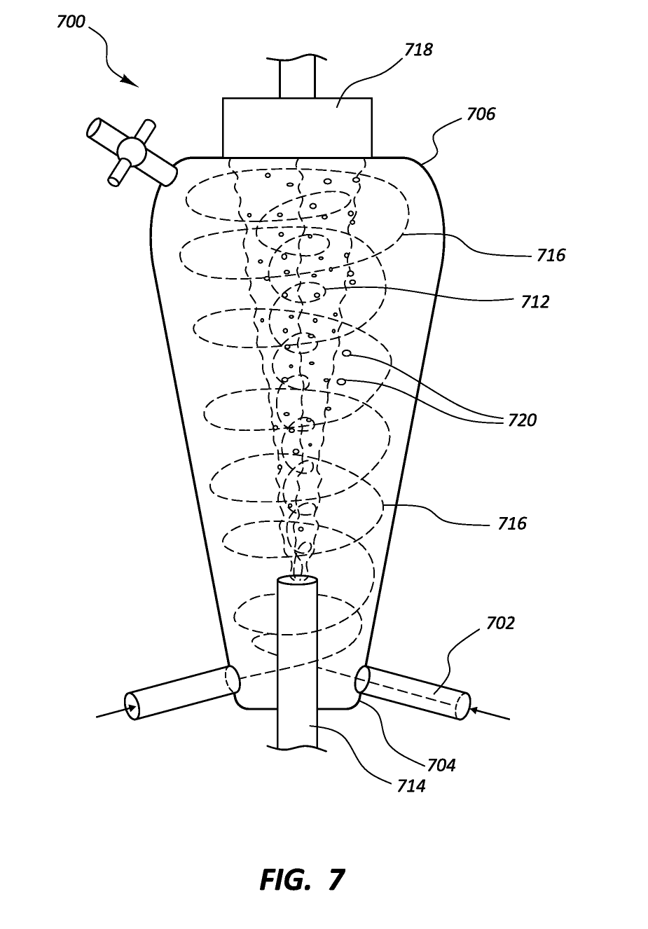

FIG. 6 illustrates an embodiment of a single vortex reactor 600 including an energy-imparting device, and FIG. 7 illustrates an embodiment of a dual vortex reactor 700 including an energy-imparting device. Energy-imparting devices are configured to impart energy to a reactor fluid in order to, for example, initiate and/or augment physical effects (e.g., mixing, heating, disrupting) and/or chemical effects (e.g., free radical formation, bond formation and/or bond breaking) in the reactor fluid or components thereof. In the embodiments illustrated in FIGS. 6 and 7, energy-imparting device is an ultrasonic horn 618 or 718, respectively, configured to impart ultrasonic energy to the reactor fluid. Other embodiments may include additional or alternative energy-imparting devices, such as lasers, microwave generators, other electromagnetic energy generators, and/or magnetic field generators for use in a mixing, separating, heating, cooling, and/or containment (e.g., plasma containment) process.

In preferred embodiments, at least one energy-imparting device is positioned relative to a reactor body so as to impart energy in a direction substantially aligned with the longitudinal axis of the reactor body. For example, an energy-imparting device may be positioned at a first end and/or a second end of a reactor such that at least some of the energy is deliverable at one or more radial center portions of the reactor.

In the embodiment illustrated in FIG. 6, ultrasonic horn 618 can be positioned at a first end 604 of reactor 600 (e.g., near inlet ports 602). In this configuration, ultrasonic horn 618 can apply ultrasonic energy to the section where vortex 612 is initially formed. Such a configuration can beneficially provide high levels of interaction between the reactor fluid and the imparted ultrasonic energy.

In the illustrated embodiment, ultrasonic horn 618 is recessed or flush with reactor 600. In other embodiments, an ultrasonic horn can protrude into the interior of reactor 600. Ultrasonic horn 618 can be configured with a concave, convex, or any other surface configured to provide a desired streaming of cavitation bubbles into the reactor fluid. In preferred embodiments, ultrasonic horn 618 is configured to form a stream of cavitation bubbles 620 that substantially matches the shape of vortex 612. For example, ultrasonic horn 618 can be configured with a concave geometry in order to form a stream of cavitation bubbles 620 in a cone shape (e.g., hyperbolic cone) that is approximately the same geometric size and shape of the cone shape (e.g., hyperbolic cone) of vortex 612.

In the embodiment shown in FIG. 7, ultrasonic horn 718 is positioned at a second end 706 of reactor 700 (opposite first end 704). In this configuration, ultrasonic horn 718 can apply ultrasonic energy to a portion of reactor 700 where fluid flow changes from an outer vortex 716 to an inner vortex 712. Such a configuration can beneficially provide high levels of interaction between the reactor fluid and the imparted ultrasonic energy.

Ultrasonic horn 718 can be configured with a concave, convex, or any other surface configured to provide a desired streaming of cavitation bubbles into the reactor fluid. In preferred embodiments, ultrasonic horn 718 is configured to form a stream of cavitation bubbles 720 that substantially matches the shape of inner vortex 712. For example, ultrasonic horn 718 can be configured with a concave geometry in order to form a stream of cavitation bubbles 720 in a cone shape (e.g., hyperbolic cone) that is approximately the same geometric size and shape of the cone shape (e.g., hyperbolic cone) of inner vortex 712.

In the embodiments shown in FIGS. 6 and 7, the carrying vortex which carries the cavitation bubbles (vortex 612 and inner vortex 712, respectively) can direct and/or channel the stream of cavitation bubbles toward the vortex outlet. In some embodiments, the centripetal force acting on the stream of cavitation bubbles will force the stream of cavitation bubbles toward an axis of rotation at the center of the carrying vortex. This can beneficially concentrate the stream of cavitation bubbles into a limited volume, thereby allowing for a high density of cavitation bubbles that can advantageously initiate and/or augment physical and/or chemical effects within the reactor fluid. In some embodiments, the introduction of negative pressure caused by the fluid dynamics of the vortex or vortices of the reactor can also beneficially facilitate the formation of cavitation bubbles.

The cavitation bubble density within a given portion of the carrying vortex may depend on at least the fluid flow rate and the rate of cavitation bubble formation and collapse. In some embodiments, for example, various components of the reactor (e.g., ultrasonic horn, reactor body, reactor fluid properties, inlet ports, vortex outlet, and/or other reactor components) are tuned or otherwise configured to match a flow rate with an average cavitation bubble residence time (before collapse) to optimize a desired processing result (e.g., mixing, mass transfer, chemical reactivity, etc.).

In some embodiments, these and/or other parameters are configured to provide a cavitation bubble density that is substantially constant along a given length of the carrying vortex. For example, for a given section of the stream of cavitation bubbles traveling toward a vortex outlet, as the cavitation bubbles collapse to progressively lower the amount of cavitation bubbles within the section, the volume of the carrying vortex also becomes progressively smaller (because of the conical shape of the carrying vortex). Thus, in some embodiments, the reactor is configured and/or tuned (e.g., by configuring the ultrasonic horn, reactor body, reactor fluid properties, inlet ports, vortex outlet, and/or other reactor components) to provide a uniform or substantially uniform density of cavitation bubbles within the vortex. In other embodiments, a reactor can be configured and/or tuned to provide an increasing density or a decreasing density of cavitation bubbles along the vortex carrying the cavitation bubbles (e.g., in embodiments wherein the reactor body does not have a conical shape).

In some embodiments, an ultrasonic horn and/or other ultrasound energy producing devices can be configured to operate within a frequency range of about 20 kHz to about 3 MHz, preferably from about 20 kHz to about 1.2 MHz. In some embodiments, frequencies less than about 100 kHz are suitable for promoting physical effects to the reactor fluid, and frequencies above about 100 kHz are suitable for promoting chemical effects in the reactor fluid. In some embodiments, a frequency range of about 500 MHz to 900 MHz is useful for imparting chemical effects such as free radical production. The ultrasonic horn and/or other ultrasound energy producing devices may be configured to provide ultrasound energy having wave amplitude matched to a desired level of energy input, for example, to match the energy input required to initiate and/or augment a desired activity within the reactor.

Some embodiments may include more than one ultrasonic horn and/or other ultrasound generating device. For example, some embodiments may include a first probe positioned at or near a first end (e.g., at or near where one or more inlet ports are located), and a second probe positioned at or near a second end (e.g., at or near where a vortex outlet is located in a single vortex embodiment, or at or near where the outer inner vortex forms in a dual vortex embodiment). In some embodiments, a first and second probe may be configured to operate at different frequencies and/or wave amplitudes. For example, a first probe may be configured to induce and/or augment a first chemical and/or physical effect while a second probe may be configured to induce and/or augment a second chemical and/or physical effect. In some embodiments, a plurality of ultrasound generating devices may be utilized in conjunction to provide standing waves within an associated reactor body.

Embodiments such as those illustrated in FIGS. 6 and 7 can provide a variety of benefits. For example, the effects of the carrying vortex can provide rapid movement of the cavitation bubbles away from the ultrasonic horn or other energy imparting device. This can advantageously protect the energy imparting device from erosion damage. In addition, because the cavitation bubbles are concentrated at the inner portions of the carrying vortex, the walls of the reactor are protected from erosion caused by cavitation bubble collapse.

B. Mixing/Separating

In the embodiment illustrated in FIG. 6, vortex 612 can subject a reactor fluid to an array of centrifugal and centripetal forces within the reactor. In some circumstances, components of the reactor fluid are mixed by passing the fluid through the reactor. In some circumstances, components of the reactor fluid are separated by passing the fluid through reactor 600 (e.g., by solids and/or liquids having relatively greater density concentrating in the outer portions of vortex 612 where centrifugal forces are relatively high, and solids and/or liquids having relatively lower density passing to the inner portions of vortex 612 where centrifugal forces are relatively low). Similarly, outer vortex 716 and/or inner vortex 712 of the embodiment illustrated in FIG. 7 can enable separation of components of the reactor fluid through similar functionality. For example, solids and/or liquids having relatively greater density can concentrate in outer vortex 716 while solids and/or liquids having relatively lower density are passed to inner vortex 712).

The embodiment illustrated in FIG. 6 includes one or more wall outlets 632 disposed in the reactor wall, and the dual vortex embodiment illustrated in FIG. 7 may include one or more wall outlets disposed in the reactor wall (not shown). The one or more wall outlets 632 are configured to provide collection of a heavy phase and/or solids phase from the reactor fluid. Some embodiments, such as those that have a horizontal or semi-horizontal orientation, are configured to utilize gravity to induce and/or aid in a separation process. The illustrated embodiments can include one or more similarly configured wall outlets.

In some embodiments, fluid flow through a reactor can be modulated by adjusting a vortex outlet (such as vortex outlet 614 or vortex outlet 714) and/or one or more wall outlets. For example, a vortex outlet can be adjusted so as to reduce or eliminate fluid flow through the vortex outlet while the one or more wall outlets are opened to allow fluid flow through the one or more wall outlets. In this manner, a processing zone having an increased fluid residence time can be formed within the reactor. For example, fluid flowing through one or more inlet ports at a first end (such as first end 604) and flowing along an inner surface of the reactor and out of one or more wall outlets at or near a second end (such as second end 606) can provide a motive force for maintaining a rotating processing zone at the axis of the reactor. The processing zone can be maintained for as long as desired (e.g., to complete a reaction within the processing zone) before readjusting the reactor (e.g., by opening vortex outlet 414) in order to alter fluid flow through the reactor. As explained in more detail below, such a processing zone can also be configured to include one or more solid objects in order to initiate or augment desired processes.

In some embodiments, a reactor can include a plurality of wall outlets configured to collect a portion of the reactor fluid (e.g., concentrated gases, liquids, and/or solids) that separate and/or concentrate at corresponding areas within the reactor. In some instances, the application of ultrasound energy functions to separate a solution into discrete longitudinal bands in separation zones that correlate to the wavelength of the applied energy. Reactor embodiments including one or more wall outlets can be used to collect and/or separate one or more components of a reactor fluid based on the formation of longitudinal separation zones within the reactor. Such separation zones may be formed and/or enhanced through the application of energy to the fluid (e.g., ultrasonic energy and/or any of the other energy sources described herein), through centripetal and/or centrifugal forces caused by flow through the reactor, and/or through other mass and/or other energy transfer processes.

In some embodiments, an ultrasonic horn or other energy-imparting device can protrude a distance into the reactor so as to impart energy in a direction transverse to the axis of the vortex. For example, an ultrasonic horn can protrude into the reactor to the vortex outlet or substantially to the vortex outlet, and the ultrasonic horn may cause the reactor fluid to organize into longitudinal separation zones.

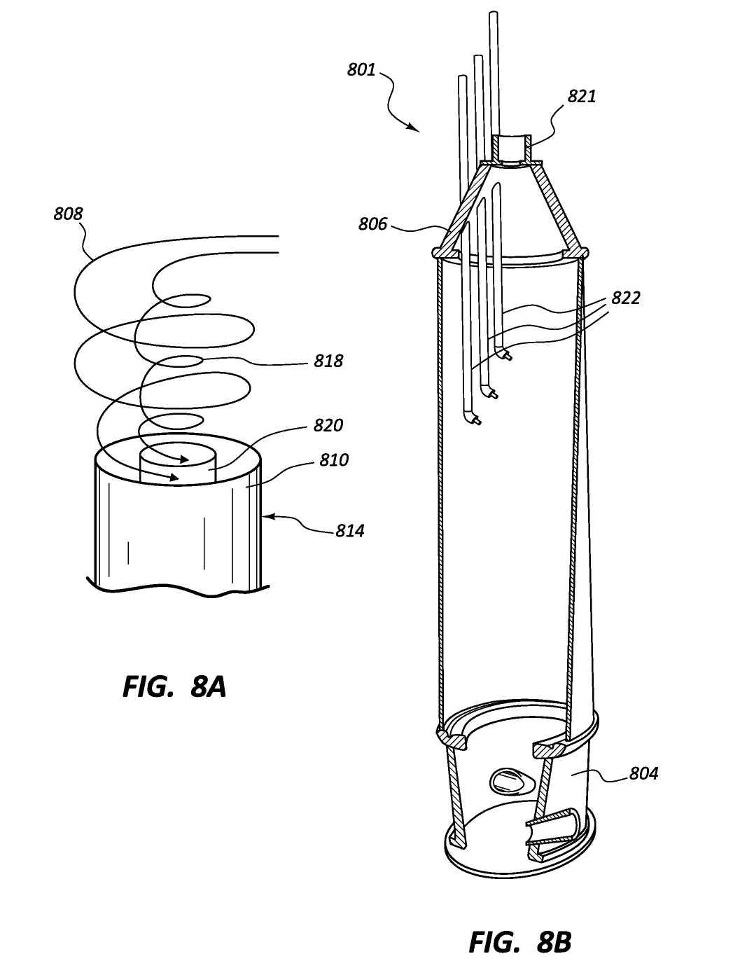

FIG. 8A illustrates an embodiment of a vortex outlet 800 configured as a plurality of concentric sections. Such an outlet can be used to collect and/or separate different components of the reactor fluid as they concentrate into different radial separation zones within the reactor. For example, each concentric section can be matched to a corresponding radial separation zone generated within the reactor such that fluid components concentrating in a first radial separation zone 808 exit through a first concentric section 810 and fluid components concentrating in a second separation zone 818 (e.g., located radially inward of first separation zone 808) exit through a second concentric section 820 (e.g., located radially inward of first concentric section 810).

FIG. 8B illustrates an embodiment of a vortex reactor 801 configured for operation in a centrifugation application. In one particular application, the vortex reactor 801 may be utilized for the separation of exfoliated layered compounds, such as compounds produced through solvent exfoliation, surfactant exfoliation, or mechanochemical delamination (e.g., through ultrasound). In one example, graphene flakes are suspended in the fluid medium and are separated by size as a result of passing through the vortex reactor 801. The vortex reactor is beneficially configured to provide separation into a plurality of size distributions in a continuous manner, as opposed to requiring a series of separate steps to achieve the plurality of size distributions.

During operation, the vortical motion of the fluid as it moves from the first end 804 to the second end 806 will cause the lowest density fraction to concentrate near the axis of the vortex, while fractions of progressively greater density will concentrate at positions extending radially outward from the axis. As shown, a series of outlet tubes 822 are arranged at different radial separation zones and at different elevations. Positioning the outlet tubes 822 at different elevations and/or at different tangential angles to the axis enables the outlet tubes 822 to function with minimal disturbance to the vortex. In an example of separating graphene flakes, the smallest flakes (which typically have the least relative value) will concentrate at the axis and will exit through the central outlet 821 at the second end 806, while flakes having larger sizes are collected by the outlet tubes 822. The outlet tubes 822 may have a tubular shape, airfoil shape, or other shape.

Some embodiments may also include an energy-imparting device to aid in forming one or more separation zones. For example, the application of sound energy (e.g., through use of a tactile sound transducer or an ultrasound horn) can promote the concentration of solids in distinct bands correlating to node points along the wavelength of the frequency used. Additionally, or alternatively, an energy-imparting device may be used to provide mechanochemical delamination of the target compound (e.g., graphene flakes). In these and other embodiments, sufficiently pre-processed and sized graphite may be introduced into the reactor via the fluid inlet ports.

C. Desalination

Some embodiments include a porous structure within the wall. For example, some separation processes may result in one portion of the reactor fluid exiting the reactor through the porous structure while another portion is maintained within the inner sections of the reactor until exiting the reactor at the vortex outlet. In one example, a desalination process results in a purified or salt-reduced phase being forced and/or filtered through the porous structure (e.g., sized to sufficiently provide the desired desalination functionality) while a higher salt concentration phase is maintained within the reactor (e.g., within the inner portions of the vortex of a single vortex embodiment or within the inner vortex of a dual vortex embodiment) until exiting through the vortex outlet.

In another example, a vortex reactor provides desalination by forcing saltier water (which is relatively more dense) toward the outer portions of the reactor (e.g., and toward the porous separation structure) while less salty water (which is relatively less dense) tends to concentrate at the inner sections of the reactor (e.g., within the inner portions of the vortex of a single vortex embodiment or within the inner vortex of a dual vortex embodiment). In some embodiments, the denser, saltier water exits through one or more wall outlets. In some embodiments, the less dense, less salty water exits through the vortex outlet (e.g., after passing through an element such as a reverse osmosis membrane).

In some embodiments, a vortex reactor may be configured as a vortex reverse osmosis unit. For example, a single vortex embodiment may be configured with a membrane and an annular space between the membrane and an outer wall of the reactor, allowing desalinated water to pass through the membrane and into the annular space. In another example, an outer membrane and an inner membrane are configured as a dual vortex reverse osmosis unit. For example, an outer membrane can form the outer wall within which the outer vortex travels and abuts against, while an inner membrane is positioned axially within the outer membrane separating the inner vortex from the outer vortex. Desalinated water may be pushed through the outer membrane through action of the outer vortex (e.g., through applied positive pressure), while further desalinated water may be pulled from the inner vortex (e.g., through induced negative pressure resulting from the vortical activity) into an annular space between the outer and inner membranes. In some embodiments, one or more of the microporous membranes may be formed in an accordion or bellows fashion providing ease of packaging, storage, unfolding and setting up, and the like.

In some embodiments, the reactor wall is formed, in whole or in part, of a material configured to operate as an electrode (e.g., a material across which a voltage may be applied). For example, the reactor wall may be formed, in whole or in part, of a porous material across which a voltage is applied. Such a reactor can be used in a capacitive desalinization process in which salt-containing water passes through the porous structure of the reactor wall where dissolved ions (e.g., sodium and chloride ions and/or other ions) are held in place by the electrically active properties of the reactor wall. In some embodiments, the reactor wall is formed in whole or in part from a carbon aerogel material.

In some embodiments, at least a portion of the desalinated fluid (e.g., water that has a reduced salt content or that has been purified of salts) passes out of the porous reactor wall and is recycled back into the interior of the reactor, where it may pass through the vortex outlet of the reactor. In some embodiments, at least a portion of the desalinated fluid passes out of the porous reactor wall to the exterior of the reactor through one or more wall outlets. For example, the reactor may be configured with a recycle rate sufficient to provide a desired level of desalination for a final product. The recycle rate may be selected according to desired operation parameters, for example, desired operation modes (e.g., continuous, batch, fed-batch, etc.), fluid parameters, mass and/or energy input and output flow rates, etc. In some embodiments, the vortex reactor is regenerated by removing the voltage from across the portions of the reactor wall to which it is applied and backwashing to remove ions contained within the wall. Recovered ions may be directed to one or more downstream processes and/or collected for value adding uses.

In some embodiments, the time and/or volume capacity before a regeneration cycle must be run is a function of the size of the section of the vortex reactor wall configured to remove ions. For example, longer and/or thicker reactor wall sections can increase processing capacity between regeneration cycles.

In some embodiments, the one or more wall outlets (including porous structure embodiments) disposed in the reactor wall are configured to collect and/or separate a portion of the reactor fluid from the reactor based on kinetic and/or thermal energy density. For example, as the reactor fluid flows through the reactor, higher energy molecules (e.g., higher temperature) may concentrate in the outer portions of the reactor near an inner surface of the reactor (e.g., due to greater inertia of the higher energy fluid molecules) while lower energy molecules (e.g., lower temperature) may concentrate toward the inner portions of the reactor.

D. Pressure Modulation

In some embodiments, a reactor can be configured to operate with a pulsating fluid action. For example, a reactor may be configured to exhibit a pulsating action by configuring the inlet fluid flow to enter the reactor in a pulsating fashion and/or by allowing such a pulsating configuration to self-organize as a result of interaction between the bleed opening, reactor fluid, reactor body, and/or vortex outlet.

In some embodiments, negative pressure introduced by the fluid flow can pull an amount of air or other gas through a bleed opening and into the interior of the reactor before the fluid flow pulsates back to a substantially neutral pressure, stopping and/or slowing the pulling of gas into the reactor body. Afterwards, negative pressure can increase again to form another pulse within the reactor. Such a pulsating operation can provide a variety of benefits. For example, in some circumstances it may be desirable to subject a reactor fluid to alternating pressures and/or fluid dynamics in order to augment and/or otherwise modify processing parameters.

Some pulsing reactor operations can be initiated and/or strengthened by introducing a resonant pressure change into the reactor body. For example, the bleed opening may be sequentially opened and closed at a given frequency in order to develop and/or strengthen a pulsating activity within the reactor. The resonant pressure change can be configured to set the reactor at a desired pulsing operation (e.g., with a desired amount of gas inflow, desired oscillation frequency, etc.). In some embodiments, an induced negative pressure may be substantially constant.

Some embodiments may be configured to have a volume of gas positioned above the reactor fluid or otherwise in fluid communication with the reactor fluid. Some embodiments can additionally include a gas volume encased in a separate vessel, such as a vessel of variable volumetric capacity, connected to the volume of gas above the reactor fluid. Such a separate vessel can be configured to induce or attenuate surges in pressure in the reactor. In some embodiments, a desired gas or gas mixture can be placed in the volume of gas and/or into a separate vessel in order for the gas or gas mixture to be entrained into the reactor fluid. For example, gas molecules can be entrained with the aid of ultrasonic energy imparted by an ultrasonic horn and/or can be entrained in the reactor fluid in order to provide nucleation sources to promote cavitation bubble formation.

In some embodiments, a reactor may be configured to be open to the surrounding atmosphere (e.g., through the use of a bleed opening and/or other openings or valves). Such embodiments will typically operate at or near ambient atmospheric pressures, though pressure fluctuations may be introduced, as described above, and the fluid dynamics of the one or more vortices may introduce negative pressures into the reactor. In other embodiments, a reactor may be pressurized to a level above ambient atmospheric pressure in order to initiate or augment desired physical and/or chemical effects to the reactor fluid. For example, a reactor may be pressurized to a level of about 1 to 20 bar (gauge), or about 1 to 10 bar (gauge), or about 1 to 5 bar (gauge), or about 1 to 3 bar (gauge).

E. Thermal Management

One or more embodiments of the present disclosure can be useful for thermal management of a reaction and/or process. For example, in circumstances in which heat is generated in the reactor fluid (e.g., as a result of exothermic chemical reactions, physical mixing, and/or friction), one or more embodiments may be configured to sufficiently carry away excess heat through an outlet at a rate sufficient to maintain a desired temperature range within the reactor, such as a steady state reaction temperature. In some embodiments, the removed fluid may be treated by passing the removed fluid through a heat exchanger before passing the fluid back to the reactor or passing it onto one or more separate processes.

In some embodiments, fluid exiting one or more wall outlets is cooled using an external heat exchanger. The cooled fluid can then be rerouted to the reactor, such as when it is desired to increase the residence time of the fluid and/or to lower the temperature within the reactor. In some embodiments, the concentration of higher temperature fluid along the inner surface of the reactor provides increased cooling efficiency of the reactor. For example, the one or more wall outlets can be disposed so as to draw the higher temperature fluid from the reactor, as described above, and/or a heat-exchange jacket can be contacted to the outer surface of the reactor.

F. Internal Object

Although less preferred for most implementations, some embodiments may include one or more internal objects positioned within the reactor body, as explained below. Other embodiments omit internal objects positioned in a manner that risks impeding vortical flow within the reactor.

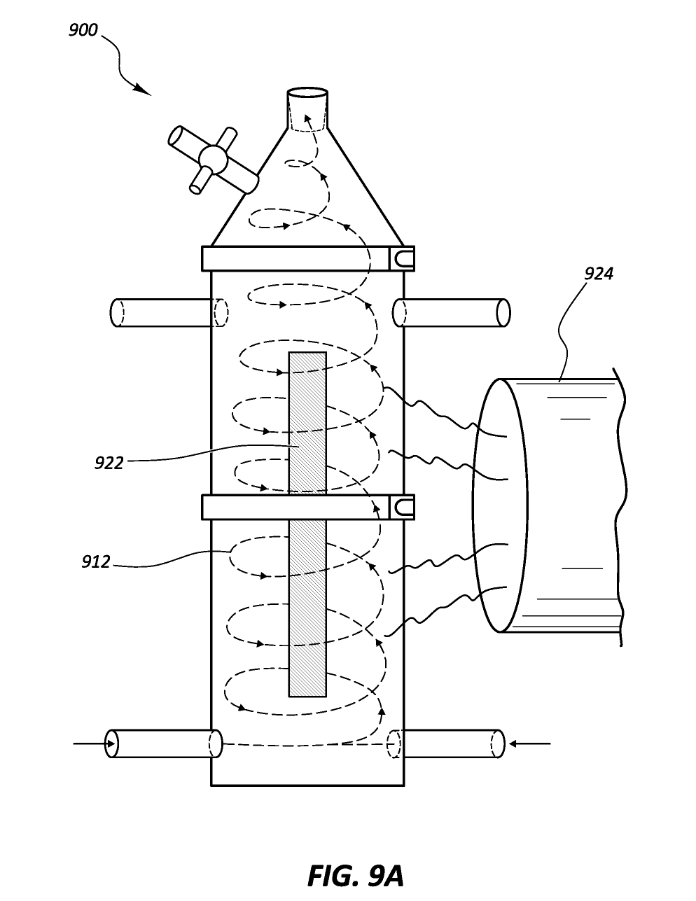

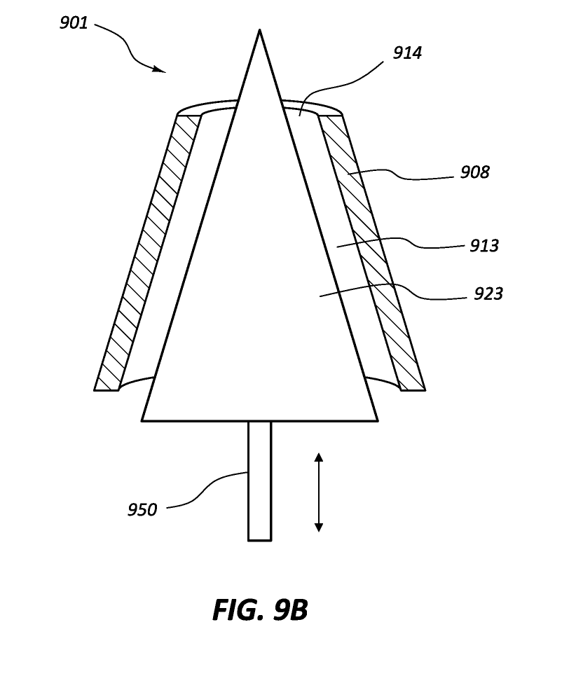

FIG. 9A illustrates an embodiment of a single vortex reactor 900 configured to include a solid object 922 within vortex reactor 900. In the illustrated embodiment, solid object 922 is disposed along a longitudinal axis of reactor 900, such as within or partially within an area occupied by vortex 912. Solid object 922 may be formed from a material configured to initiate and/or enhance one or more desired effects upon the reactor fluid. For example, solid object 922 can be formed as a catalyst (e.g., a catalyst metal) configured to drive or enhance a reaction within the reactor fluid. Additionally, or alternatively, the solid object is configured to alter fluid flow within reactor 900. In some embodiments, solid object 922 is formed from one or more metals, alloys, ceramics, polymers, and/or graphene, for example. In some embodiments, solid object 922 includes integrated circuit materials. In some embodiments, solid object 922 includes nanoparticles and/or other nanomaterials, such as nano magnets.

In some embodiments, solid object 922 is disposed along the longitudinal axis of reactor 900. Alternatively, solid object 922 can be positioned in other sections of reactor 900, such as in a position closer to the inner surface of reactor 900. In some embodiments, solid object 922 is fixed in position. In other embodiments, solid object 922 is suspended in position and/or partially fixed in position. In some embodiments, a solid object is disposed within or partially within a vortex outlet of the reactor.

In some embodiments solid object 922 is configured to be rotatable within reactor 900, such as by coupling solid object 922 to a rotatable shaft. In other embodiments, solid object 922 is freely suspended within reactor 900. For example, in some embodiments, solid object 922 may self-position along the longitudinal axis of the reactor 900 during operation of reactor 900 (e.g., may self-position as vortex fluid flow within reactor 900 moves solid object 922 into position).

In some embodiments, solid object 922 can be formed as a screen and/or latticed structure. In some embodiments, solid object 922 has a tubular shape. In some embodiments, solid object 922 includes filaments, extensions, grooves, channels, holes, tendrils, wires, and/or other surface features configured to increase surface area of solid object 922.

Although the illustrated embodiment includes a single solid object 922, other embodiments may include more than one solid object. For example, some embodiments may include an array of solid objects positioned along the axis, inner surface, and/or elsewhere within the reactor.

FIG. 9A also illustrates an external force generator 924. External force generator 924 can be included in addition to, or in lieu of, an energy-imparting device, for example. In the illustrated embodiment, external force generator 924 is configured to provide a force (e.g., electrostatic, electromagnetic, magnetic) upon solid object 922. Such a force can be variable or static. External force generator 924 may provide a number of benefits, such as enhancing a catalytic effect of solid object 922 and/or augmenting a desired process within the reactor.

FIG. 9B illustrates an embodiment of a reactor 901 including a reactor body 908 having an inverted cone shape and an inner object 923 having a shape substantially corresponding to the shape of the reactor body 908. As shown, the inner object 923 is longitudinally translatable with respect to the reactor body 908 (e.g., through axial movement of a shaft 950), such that the size of an annular space 913 is controllable by adjusting the relative position of the inner object 923 with respect to the reactor body 908. Such embodiments beneficially allow the size of the annular space 913 to be adjusted to suit a given application. The cone shape of the reactor body 908 also enables the fluid flow to accelerate as it progresses toward narrower portions of the annular space 913 toward the outlet 914. Such embodiments may also include one or more energy-imparting devices (e.g., ultrasonic transducers), which may be mounted on the outside of the reactor body 908 and/or at one or more ends of the reactor.

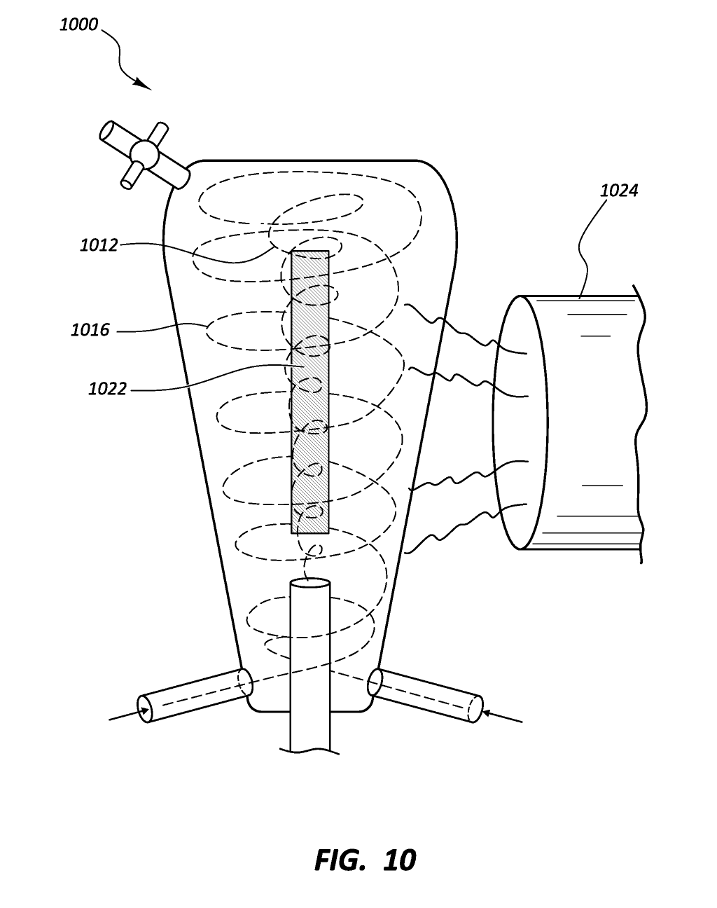

FIG. 10 illustrates an embodiment of a dual vortex reactor 1000 configured to include a solid object 1022 within the reactor. Solid object 1022 and an external force generator 1024 may be configured similar to like components described in relation to FIG. 10. In the illustrated embodiment, solid object 1022 is disposed along the longitudinal axis of reactor 1000 within an inner vortex 1012. Alternatively, solid object 1022 is positioned in other sections of reactor 1000, such as in a position closer to the inner surface of reactor 1000 and/or in a position wherein contact with an outer vortex 1016 is provided. In some embodiments, solid object 1022 can be fixed in position. In other embodiments, solid object 1022 can be suspended in position and/or partially fixed in position. For example, a solid object may be suspended so as to self-position along the longitudinal axis of the reactor in response to vortex forces.

G. Collection Tank

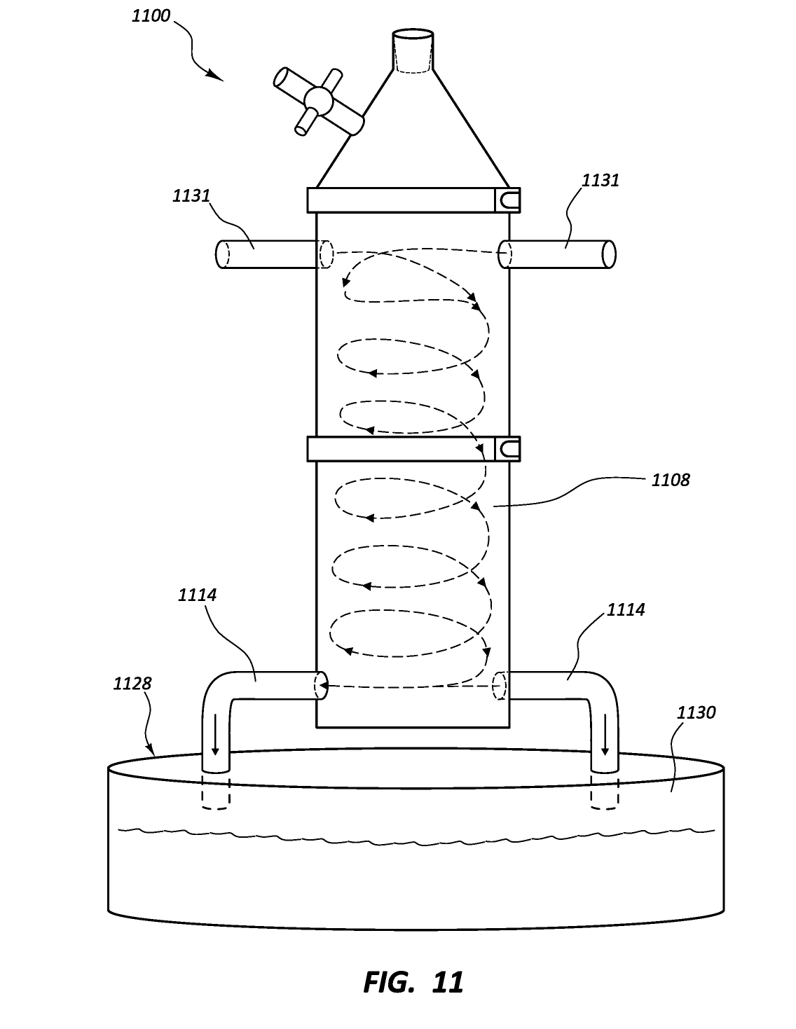

FIG. 11 illustrates an embodiment of a single vortex reactor 1100 associated with a collection tank 1128. Vortex reactor 1100 illustrated in this embodiment is shown in a reverse or downflow operation with fluid entering through ports 1131. As shown, vortex outlets 1114 are configured to direct fluid exiting reactor body 1108 into collection tank 1128. Collection tank 1128 can be, for example, a storage tank for storing the fluid received from the reactor, a separate reactor and/or separator for performing one or more downstream processes, or a holding tank for holding a volume of reactor fluid to be recycled back to vortex reactor 1100. In some embodiments, collection tank 1128 includes an air space 1130 allowing the exiting end of vortex outlets 1114 to be open to air space 1130. Air space 1130 can allow air to travel up through vortex outlet 1114 and into reactor body 1108 to relieve negative pressure build up within the reactor and/or to otherwise alter fluid flows and/or pressure changes. Some embodiments may also include an ultrasound or other transducer mounted at an end of the reactor.

In some embodiments, collection tank 1128 may not include an air space 1130 and/or the exiting end of vortex outlet 1114 is not open to an air space so that continuous liquid exits from vortex outlet 1114 to liquid contained in collection tank 1128. In this way, air is not allowed to travel up through vortex outlet 1114 and into reactor body 1108. By adjusting vortex outlet 1114 to either be or not be in communication with an air space one can selectively increase or decrease pulsation of fluid in reactor 1100.

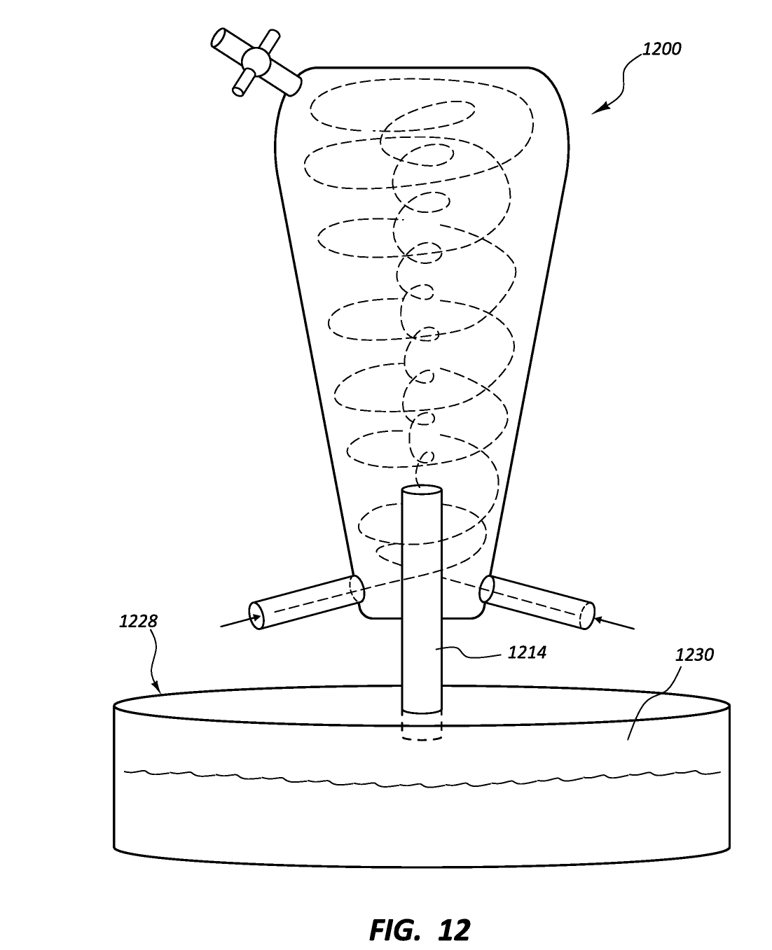

FIG. 12 illustrates an embodiment of a dual vortex reactor 1200 associated with a collection tank 1228 having an air space 1230 joining with a vortex outlet 1214. The embodiment illustrated in FIG. 12 may function similarly to the embodiment illustrated in FIG. 11, other than those effects caused by the use of a dual vortex reactor as opposed to a single vortex reactor. The embodiments illustrated in FIGS. 11 and 12 may be particularly beneficial in embodiments operating in a pulsating mode. For example, it has been observed that by allowing the exiting end of the vortex outlet to be open to an air space, a pulsating operation can be augmented (e.g., better maintained, more quickly initiated, having stronger pressure changes during a pulse cycle, etc.).

H. Hydraulic Parameters

Embodiments described herein can include a variety of variables that can be configured to provide a desired outcome. For example, hydraulic residence time, reactor volume, reactor size and shape (e.g., length to diameter ratio), flow velocity, and/or flow rate can be configured to provide a desired outcome. For example, the reactor volume and fluid flow rate can be configured together to provide a desired hydraulic residence time within the reactor.

For example, the residence time can be increased as desired by applying known process engineering techniques, such as recycling some portion of the outlet stream back to the inlet. By way of example, if the total fluid volume of a reactor were 100 liters and the flow rate were 100 liters per minute, the residence time would be one minute. If 10 L/min were withdrawn from the outlet stream, 90 L/min were recycled back to the reactor inlet, and 10 L/min of fresh feed were introduced to the reactor volume per minute, the effective residence time would be 10 minutes. To provide thermal management as described above, the 90 L/min recycle stream or some portion thereof could be passed through a heat exchanger.

In preferred embodiments, a length to diameter ratio (L/D ratio) is selected to be sufficiently high enough to allow a negative pressure to form in the reactor. For example, given otherwise similar operating parameters (e.g., input pressure of reactor fluid, bleed opening diameter, outlet size and shape), a low L/D ratio can limit the ability of the flowing fluid to form a sufficient vortex and/or to create desirable negative pressure within the reactor. In preferred embodiments, the L/D ratio is about 1.0 or more, or is about 1.5, 2.0, 2.5, 3.0, 3.5, 4.0, 4.5, 5.0, 5.5, 6.0, 6.5, 7.0, 7.5, 8.0, 8.5, 9.0, 9.5, or 10.0 or more. In some embodiments, certain parameters may increase a preferred range of L/D ratio, such as increased input pressure of reactor fluid, smaller bleed opening diameter, and/or smaller vortex outlet diameter.

Some embodiments may include a gas, liquid, solid, and/or plasma that can be entrained, mixed with, or generated within the reactor fluid. For example, a gas, liquid, solid, and/or plasma can act as a nucleation source for cavitation bubble formation and/or as a source of oxygen, hydroxyl, other radicals, and/or catalysts.

Some embodiments may include more than one vortex reactor. For example, a vortex reactor system can include a plurality of vortex reactors arranged in series and/or in parallel.

I. Waste Disintegration

One or more embodiments described herein may also be useful for disintegrating waste products or waste streams, such as sewage sludge, industrial sludge, or other solid or semi-solid waste streams. In some circumstances, downstream processes are enhanced or made more efficient when a waste stream has a smaller average particle size and/or has been through a disintegration treatment. In a wastewater treatment example, smaller particle sizes allow greater efficiency of microbial anaerobic and aerobic degradation of sludge, resulting in less sludge requiring dewatering and further downstream treatment.

In preferred embodiments, a vortex reactor for disintegrating a waste product or waste stream is configured to operate under a gauge pressure of about 1 to 5 bar, or about 2 to 3 bar. Such pressure configurations may be applied in waste disintegration applications, and may also be applied in other applications described herein, such as LCO Processing, Cetane Number boosting, and pharmaceuticals destruction applications.

In preferred embodiments, a vortex reactor is configured for disintegrating a waste product or waste stream using audible sound within a range of about 5 to 20 kHz, or about 7 to 17 kHz, or about 12 kHz. In other embodiments, a vortex reactor may be configured to operate at higher or lower frequency ranges (including sub-audible ranges) in order to most efficiently disintegrate a waste stream or a targeted component within the waste stream. In preferred embodiments, a vortex reactor for disintegrating a waste product or stream is configured to operate under a gauge pressure of about 1 to 5 bar, or about 2 to 3 bar.

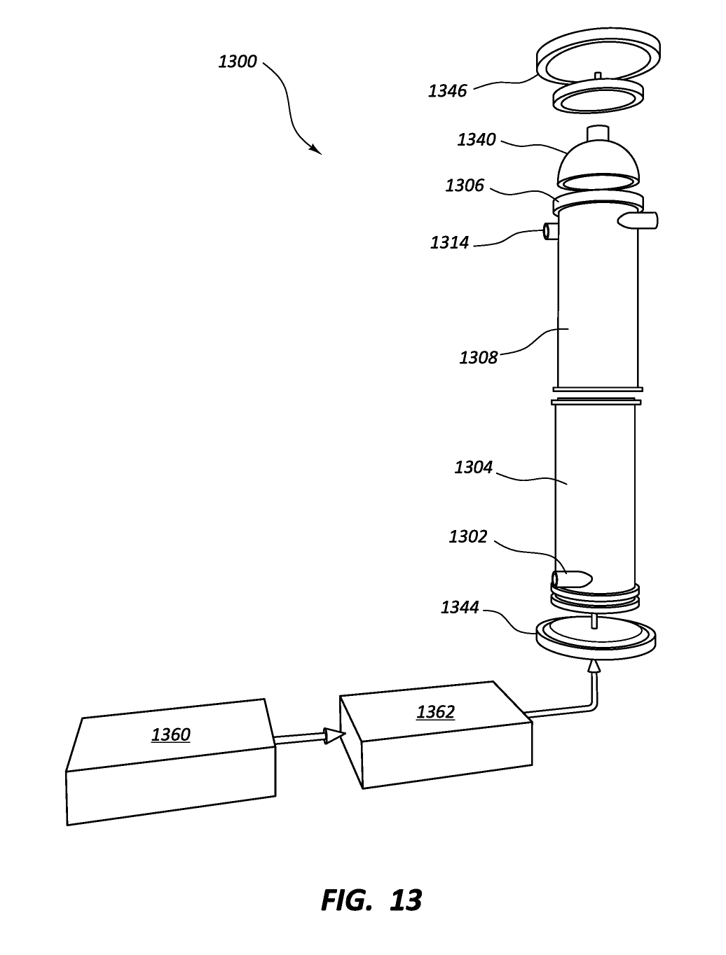

FIG. 13 illustrates (in partially exploded view) an embodiment of a vortex reactor 1300 configured for disintegrating a waste sludge. The illustrated embodiment includes a first tactile sound transducer 1344 disposed near a first end 1304. The illustrated embodiment also includes an inlet port 1302 leading to the interior of a reactor body 1308, outlets 1314, and a cap 1340 configured to seal the interior of the reactor body 1308. In other embodiments, the function of the inlet port(s) and outlet(s) can be reversed, such that the reactor functions in either a downflow mode or an upflow mode according to the relative positions of the inlet port(s) and outlet(s).

Some embodiments also include a second tactile sound transducer 1346 disposed at a second end 1306. For example, cap 1340 of the illustrated embodiment can be omitted and replaced by a second tactile sound transducer 1346. Such embodiments are particularly useful for producing standing waves of acoustic energy within reactor body 1308.

The illustrated embodiment includes a waveform generator 1360 (e.g., single or multi-channel) in communication with an amplifier 1362. The waveform generator 1360, amplifier 1362, first tactile sound transducer 1344 (and optionally second tactile sound transducer 1346) together form an energy-imparting device configured to impart audible sound energy into the interior of reactor body 1308 to promote disintegration of a targeted waste product or waste stream. Other embodiments may include different means or components for generating audible sound energy, and different components may be configured to provide desired settings. For example, one or more amplifiers may be included to provide sound energy having a desired amplitude, and a waveform generator or other sound generating device may be adjustable so as to provide sound energy in a desired frequency range (e.g., 5 to 20 kHz, or 7 to 17 kHz, or about 12 kHz).

J. High-Efficiency Sparging

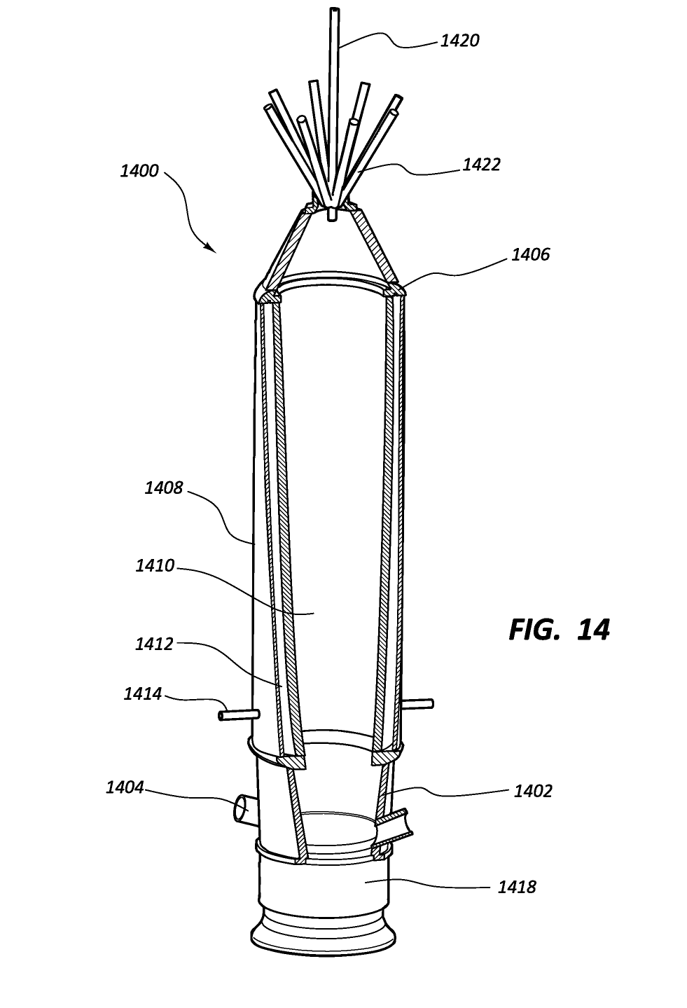

In some embodiments, a vortex reactor includes a high-efficiency sparger. FIG. 14 illustrates a single vortex reactor embodiment having a sparger configuration. As shown in FIG. 14, a reactor 1400 includes a first end 1402 where fluid may be admitted to the reactor through tangentially oriented inlets 1404, and a second end 1406 where the fluid exits the reactor. The body of reactor 1400 includes an outer wall 1408 formed of a fluid impermeable material, an inner wall 1410, and an annular space 1412 disposed between outer wall 1408 and inner wall 1410. Sparging gas may be admitted into annular space 1412 through one or more gas inlets 1414 extending from outer wall 1408 and providing access to annular space 1412. Optionally, reactor 1400 may include an energy-imparting device 1418, such as an ultrasound transducer or other energy-imparting device.

In preferred embodiments, inner wall 1410 is formed of a highly porous, sintered metal material to generate small bubbles with high surface area to volume ratio (e.g., relative to a drilled pipe sparger).

Efficient mass transfer between the gas bubbles and the reactor fluid is also contributed to through action of the vortex generated within reactor 1400. Sparged gas bubbles will typically have a lower density than the associated reactor fluid, and will therefore radially move toward the center of the vortex at the axis of reactor 1400, contacting the reactor fluid as they move. This generally radially directed movement of the bubbles, in addition to other bubble movement patterns within the reactor (e.g., vertically upward) can provide efficient mass transfer effects between the sparged gas and the reactor fluid.

In operation, as bubbles move closer together and agglomerate near the axis, gas forms a column at the axis which may be removed from the process by a central exit line 1420 aligned with the axis. Valuable components of the sparging gas (e.g., when argon, xenon, and/or other valuable gases or non-reactive species are used) can be separated and optionally returned to the process or used for some other purpose (e.g., routed to an ozone generator as feed gas). The processed fluid exits via one or more fluid outlet lines 1422. In the illustrated embodiment, outlet lines 1422 are arranged radially around the axis so as to minimize disruption of the vortex.

Other embodiments may include a single outlet (e.g., fluids and gases are not separated) or different arrangements of multiple outlets. For example, an embodiment may include one or more outlets positioned such that there is a void space between the outlet and the uppermost portion of the fluid. Sparged and/or reaction-generated gas (e.g., from hydrogen production as discussed below) fills the void space and exits the outlet, while the fluid level is maintained at a sufficient level below the outlet to maintain the gas-collecting void space. Reactor 1400 can be maintained at a pressure that optimizes the desired flow rate of gas.

K. Light Cycle Oil Processing

One exemplary application of a high-efficiency sparging vortex reactor is processing/upgrading a light cycle oil (“LCO”), visbreaker diesel, and/or other fluids with high levels of aromatics (e.g., wastewater). In some embodiments, processing may involve objectives other than opening aromatic rings, such as in accelerated processing or accelerated aging of wine, vinegar, or other fluids.

In some embodiments, reactor 1400 can subject the process fluid to vortical forces, oxidant(s), noble gases, and/or catalysts, and an energy source such as ultrasound (via energy-imparting device 1418) to open aromatic rings of an LCO to make the LCO suitable as a feedstock for upgrading to diesel fuel within a refinery. Processed LCO is preferably used as feedstock for a hydrodesulphurizing unit. Ozone or a mixture of ozone, oxygen, and/or noble gases may be sparged into the reactor as described above. Additionally, or alternatively, the gas mixture may also be entrained into the fluid before it enters the reactor. In some embodiments, ozone is mixed with one or more noble gases, such as xenon and/or argon. In some embodiments, catalysts and/or reagents may also be mixed in with the LCO stream. In some embodiments, ultrasound is applied at frequencies ranging from sonic (about 20 Hz) up to ultrasonic about (5 MHz). Preferred frequencies are in the range of about 100 kHz to about 3 MHz.

In these and in other embodiments in which ozone is utilized, the solubility of the ozone may be increased by increasing the concentration of ozone gas fed to the reactor, decreasing the temperature of the fluid, decreasing the amount of solutes, decreasing the pH, and/or applying ultraviolet light. In some embodiments, ozone is injected via a Venturi injector. In some embodiments, one or more inlets are equipped with a Venturi device such that ozone may be efficiently injected into a fluid just prior to entry of the fluid into the reactor.

The goal of processing LCO is to attack double and/or triple bonds in the aromatic rings so as to cleave them open, while controlling activity of the ozone in order that it not impart any more changes to the aromatic molecules than opening the aromatic rings at double or triple bonds, which are typically the initial point of attack. Accordingly, reactor 1400 and reactor conditions can be tailored to give the ozone enough time and contact to sufficiently cleave double and triple bonds, without over-reacting with the LCO.

LCO upgrading may also be performed using the vortex reactor configuration shown in FIGS. 5A-5C. A first stream of LCO may be admitted into reactor 500 through first inlet port 502, while a second steam of LCO is admitted through second inlet port 538. The volumetric flow rates may be the same or different. Ozone, optionally including one or more noble gases such as xenon and/or argon, is sparged into one or both fluid streams. As described above, this reactor configuration can generate intense and efficient mixing of the separate streams, which in this particular application, beneficially leads to efficient attack of double and triple bonds in the aromatic rings of the LCO.

L. Crude Oil Desalting

In some embodiments, a vortex reactor can be applied in an oil desalting operation. In this example, the vortex reactor configuration shown in FIGS. 5A-5C is described in the context of a crude oil desalting process. Diluent water may be admitted into reactor 500 through second inlet port 538. The diluent water may contain surfactants or other desired compounds to enhance emulsification or provide other desired effects. The diluent water is passed toward second end 506 (e.g., through the use of pump-induced pressure), where it is imparted with a vortical motion by interior induction structure 544 of induction mechanism 532. In preferred embodiments, the flights of interior induction structure 544 can change in pitch to increase the angular velocity of the diluent water as it moves from second inlet port 538 toward second end 506.

Crude oil can be admitted to the device through first inlet port 502. The illustrated embodiment shows that oil enters the device at a 90° angle via a standard piping joint, where exterior induction structure 542 of induction mechanism 532 functions to impart vortical motion to the oil. Preferably, the flights of exterior induction structure 542 can be configured to increase the angular velocity of the oil as it passes toward second end 506. In alternative embodiments, one or more inlets can be arranged tangentially to impart a vortical motion to the crude oil, in addition to or alternative to induction mechanism 532. Also, though this example describes diluent water and crude oil as passing through particular input ports, it should be understood that the respective ports used may be reversed.

Crude oil to be treated may contain varying amounts of salts and/or other impurities, and the amount of diluent water needed to accomplish sufficient desalting will vary. Additional water may be injected into the first inlet port as needed. A gas or mixture of gases may also be sparged into the oil stream and/or diluent water stream. A heating jacket, ultrasound transducers or other means of heating crude oil may be placed at any position along the device in order to reduce oil viscosity and enhance emulsification. Alternatively, crude oil can be preheated in a separate, upstream process.

In preferred embodiments, exterior induction structure 542 and interior induction structure 544 cause the two fluids rotate in opposite directions. As the two fluids exit their respective pathways and meet at mixing zone 540, their counter-rotating masses will result in high shear mixing and efficient mass transfer of salts into the diluent solution, thereby effectively desalting the crude oil. In some embodiments, an exit tip is fixed to the discharge of one or both fluid pathways and is configured in size and shape (e.g., a nozzle-like shape) to enhance fluid contact or otherwise control the intersection of the separate fluid streams.

The illustrated embodiment includes a guide cone 546 configured to route the mixed fluid streams to a common outlet. Optionally, the mixed fluids may be subjected to an energy source (e.g., ultrasound energy and/or microwave energy) using energy-imparting device 518. Additionally, or alternatively, the diluent water may be forced through an aperture as it exits induction mechanism 532. The aperture may be configured to induce hydrodynamic cavitation in the diluent water stream. Additionally, or alternatively, saturated or superheated steam may be injected via an aperture in order to cause hydrodynamic cavitation.

M. Crude Oil Demulsifying

In some embodiments, a vortex reactor can be utilized in an oil demulsifying process. Crude oil, even after primary dewatering, still often contains emulsified or finely dispersed water, which contains most of the salts that are injurious to refinery equipment when the crude oil is processed. Example pre-treatment processes can remove most or essentially all salts and most or essentially all water from the crude oil prior to being routed to the refinery.

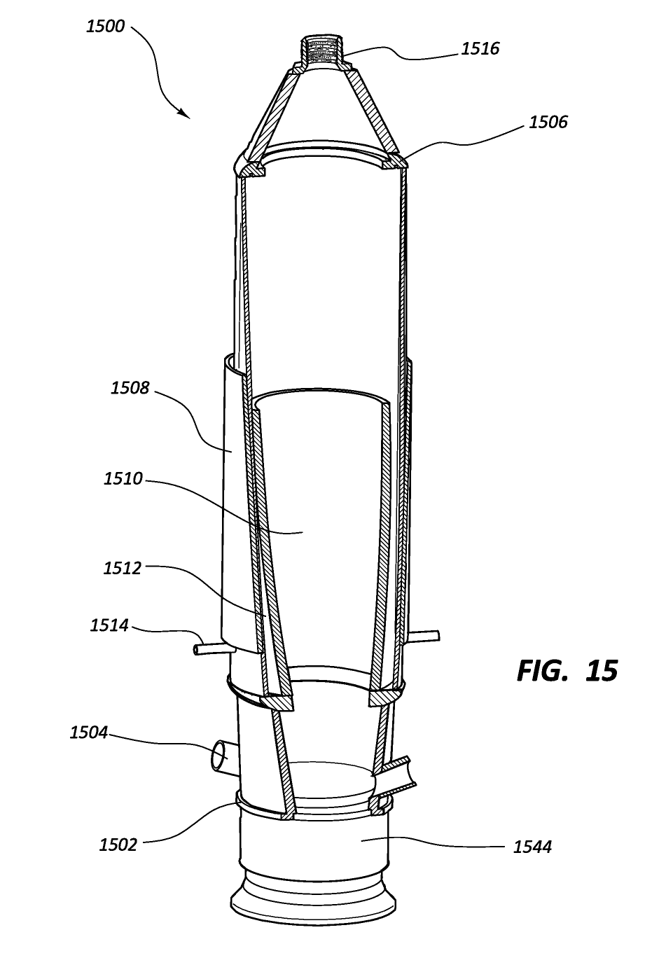

FIG. 15 illustrates a vortex reactor 1500 that may be utilized in an oil demulsifying process. Crude oil is admitted into reactor 1500 at a first end 1502 via tangentially arranged inlets 1504 and adopts a vortical motion rising in reactor 1500 toward a second end 1506. Vibrational energy is imposed on the rotating mass of crude oil using transducer 1544, which may be configured as an ultrasound transducer or tactile sound transducer. In some embodiments, a tactile sound transducer is connected to a signal generator and power amplifier to generate vibrations ranging from subsonic to about 20 kHz. Alternatively, an ultrasound transducer may emit vibrations at a frequency from about 20 kHz up to 3 MHz or more.

Reactor 1500 includes an electrically conductive shell 1508 and an electrically conductive inner structure 1510. Preferably, in use, a power supply negative is connected to ground, and a positive voltage is applied to conductive shell 1508 and conductive inner conduit 1510. The voltages may be the same or different. Thus, the mass of crude oil (with emulsified water) can be negative with respect to conductive shell 1508 and conductive inner conduit 1510, which will induce coalescence of water droplets within the crude oil.

The vortical rotation of the mass of crude oil imposes a centrifugal force on the water droplets, causing them to move toward the periphery of reactor 1500. The water droplets (which are ionic due to the relatively high salt content) will be attracted to conductive shell 1508 and conductive inner conduit 1510, forming a layer along the inner wall of inner conduit 1510, then, after reaching an adequate height toward the second end 1506, flowing over inner conduit 1510 and moving downward into annular space 1512 and toward water outlets 1514. Charged outer shell 1510 may further attract the water on its path toward the water outlets.

In some embodiments, reactor 1500 may be tilted at some angle from the vertical to allow gravity to assist in the coalescing of the water. The reactor includes an outlet 1516 where dewatered and desalted oil exits reactor 1500.

N. Biodiesel Production

The vortex reactor configuration illustrated in FIGS. 5A-5C may also be utilized in a biodiesel production process. To carry out a transesterification reaction, a mixture of methanol (and/or other alcohol) and catalyst is pumped into the reactor through second inlet port 538, while an oil (e.g., palm oil or other oil suitable for biodiesel production) is pumped into the reactor through first inlet port 502. Alternatively, the particular inlet ports through which the particular reaction components are passed may be reversed. As explained above in relation to other applications of this vortex reactor configuration, reactor 500 provides intense mixing and efficient mass transfer at mixing zone 540, maximizing completion of the transesterification reaction and thereby minimizing glyceride impurities in the biodiesel product.

After exiting mixing zone 540, further treatment may be provided using energy-imparting device 518. In some embodiments, reactor 500 can be configured so that the total mass of the fluid is still rotating after exiting mixing zone 540 (e.g., in a direction depending on the relative momenta of the separate streams). In some embodiments, such post-mixing rotation can aid in further processing, such as by promoting separation by directing glycerin byproduct toward the reactor wall. The process stream may then be routed for further downstream processing (e.g., settling tank, centrifuge, etc.).

O. Cetane Number Boosting

The vortex reactor configuration shown in FIG. 14 may also be utilized in a process for increasing the cetane number (“CN”) of a biodiesel or petroleum diesel product. Reactor 1400 may be utilized to subject the biodiesel to vortical forces, oxidant(s), noble gases, and/or catalysts, and an energy source such as ultrasound (using energy-imparting device 1418) to oxygenate olefins and thereby increase the CN. In biodiesel, a high CN would provide greater oxidative stability and would make biodiesel more suitable as a blend stock for petroleum diesel.

The reactor may be configured and operated as explained in relation to other embodiments. Ozone may be mixed with one or more noble gases, such as xenon and/or argon, and sparged into the reactor. Ultrasound may also be applied (e.g., at the preferred frequencies of about 100 kHz to 3 MHz). Processing biodiesel in this manner beneficially oxidizes unsaturated chains to high cetane ethers. Ozone is known to be destructive to molecules, thus the reactor and process conditions are configured to enable sufficient ozone contact to oxidize the olefins without detrimentally over-oxidizing the biodiesel.

P. Clarifier Operation

The vortex reactor configuration shown in FIG. 15 may also be utilized as a clarifier. Turbid water enters reactor 1500 via tangentially arranged inlets 1504 at the base, disposed above transducer 1544. As explained above, one or more power supplies (e.g., DC or AC power supplies) provide inner conduit 1510 and outer shell 1508 with an electrostatic potential. The voltage may be configured as constant or varied in sinusoidal, square wave, saw tooth wave pattern, etc. Preferably, the one or more power supplies are connected at negative to the ground, giving inner conduit 1510 and outer shell 1508 a positive potential with respect to the fluid.

As shown, inner conduit 1510 only rises part way up reactor 1500. Sonic energy or ultrasound may be applied (e.g., continuously or in pulses; at constant or varying amplitude) in order to assist in breaking the colloidal nature of the fluid.

Suspended colloidal particles responsible for water turbidity often carry a negative charge and thus will attract toward positively charged inner conduit 1510 and will attract to positively charged outer shell 1508. The voltage at outer shell 1508 may be higher than the voltage of inner conduit 1510 relative to ground in order to provide sufficient intensity across the dielectric gap of the reactor wall. The vortical motion of the fluid will support a migration of particles to the periphery since they are generally heavier than water.

A particle rich volume of water will form along the inner surface of inner conduit 1510 and rise with the rising fluid flow. This particle rich volume will overflow inner conduit 1510 and enter annular space 1512, where it will move toward and exit outlets 1514. Clarified water, now mostly or entirely devoid of particles, will continue to rise in reactor 1500 and will exit via outlet 1516.

In at least some circumstances, at some point within the reactor 1500 (e.g., at some vertical position) the pressure changes from positive to negative with respect to atmospheric pressure. This phenomenon, caused by the vortical motion of the fluid, may be exploited for beneficial effects such as the drawing of ozone into the upper part of the clarifier to destroy pathogenic agents such as bacteria, protozoa, algae, cysts, parasites, viruses etc. that are not removed with the colloidal particles. Reactor 1500 may also be used in conjunction with coagulation techniques commonly utilized in conventional water treatment.

Q. Pharmaceutical Agent Destruction in Wastewater

The high-shear mixing reactor illustrated in FIGS. 5A-5C may be utilized in a wastewater treatment application, particularly for the destruction of pharmaceutical agents in wastewater. In one example, the high-shear mixing reactor 500 is configured to operate with induced hydrodynamic cavitation (by ejecting fluid at a sufficient velocity e.g., greater than about 20 m/s) coupled with acoustic cavitation. The acoustic cavitation can be used in combination with steam injections, such as either saturated steam or high-pressure superheated steam. Such an application may be particularly useful for hospitals or other institutions where drugs are administered and bio-excretions into the wastewater stream (at the point source location) are concentrated.

R. Hydrogen Production

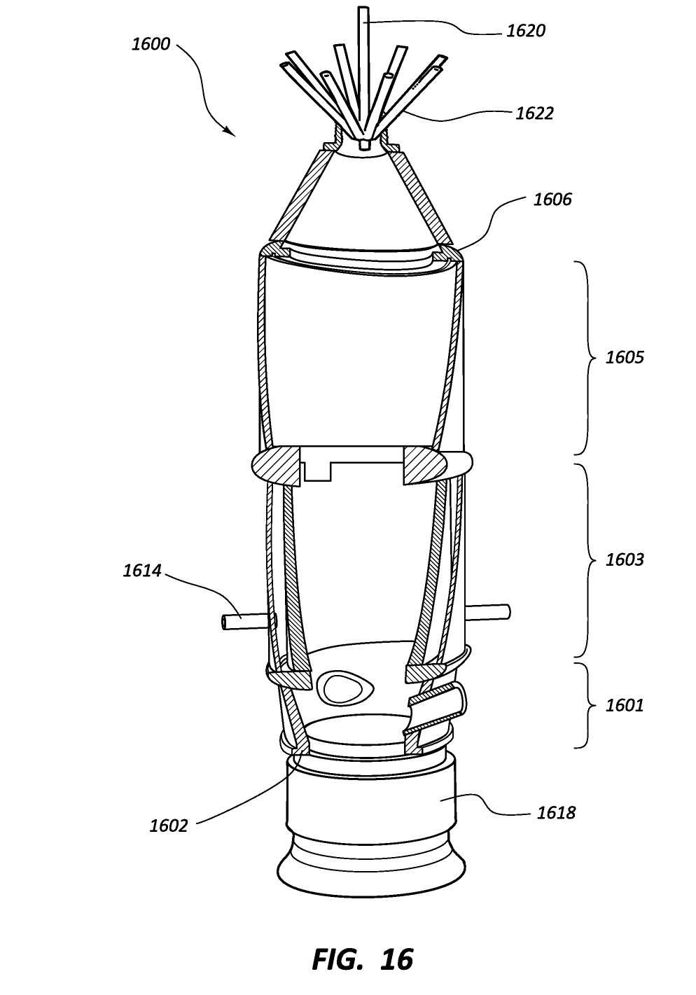

FIG. 16 illustrates an embodiment of a vortex reactor 1600 which may be utilized in a hydrogen production application. Reactor 1600 shares many features discussed above in relation to other embodiments, and may utilize one or more of those features and components. Reactor 1600 includes a transition piece 1601 configured to couple to an energy-imparting device 1618. In the illustrated embodiment, the tangentially arranged inlet ports, disposed at a first end, extend from the transition piece 1601. Reactor 1600 also includes a sparging section 1603, which includes an outer wall, an inner wall, and an annular space between the walls, as described with respect to other embodiments. The inner wall is preferably formed from a sintered metal material or is otherwise configured to provide efficient bubble formation. As shown, the sparging section 1603 includes one or more gas inlets 1614 for delivering sparging gas into the annular space and then into the reactor.

The illustrated reactor 1600 also includes an upper section 1605 that omits the sparging components of sparging section 1603. In some embodiments, upper section 1605 is formed of glass or is otherwise visually transparent to provide viewing of the reaction process. The illustrated embodiment includes a central exit line 1620 aligned with the axis of reactor 1600, and a plurality of radial outlet lines 1622 positioned to avoid disruption of the vortex. Other embodiments may omit one or the other type of outlet, or may include different outlet configurations.

In one exemplary application, water hydrolysis can be promoted within the reactor using red phosphorus and/or other catalyst (“RPC”) and an energy source such as light. For example, energy-imparting device 1618 may be configured as an ultrasound transducer, a synchrotron radiation emitter, a free-electron laser, and/or another sufficiently intense energy source. The objective of the process is to harvest the hydrogen generated by the hydrolysis.

Water mixed with RPC is admitted via the tangentially arranged inlets, causing vortical motion moving toward second end 1606. In some embodiments, the relatively more dense red phosphorous will accumulate toward the inside surface of the reactor wall due to centrifugal force. In other embodiments, the RPC is sufficiently dispersed or colloidally suspended to prevent accumulation. Sparging gas preferably includes xenon, argon and/or other noble and non-reactive gases. The relatively low thermal conductivity of these preferred gases functions to intensify cavitation bubble collapse at certain frequencies and thereby intensify the extreme conditions of temperature and pressure beneficial for promoting desired physical and chemical effects.

As hydrolysis occurs, the generated hydrogen gas moves radially toward the axis of the vortex and away from reactive compounds like OH radicals, reducing the amount of recombination. Process conditions instead favor OH radicals recombining with each other to form H₂O₂, which remains in solution with the bulk water. Because of the tendency to separate due to the effects of the vortical motion, the hydrogen and noble gas mixture is collected from central exit line 1620 while the fluid (containing water, peroxide and RPC) exits via radial outlet lines 1622.

The hydrogen product can be separated from the noble gases for use as a fuel. The noble gases and/or the RPC can be recycled to reactor 1600. Even if the RPC is a relatively low cost input, there are advantages to recycling because ultrasound tends to remove pacifying coatings on catalysts and reduce particle size. Over a number of cycles through the reactor, recycled catalyst may become progressively more active. The hydrogen peroxide rich effluent fluid can be heat treated to strip the oxygen for recovery. Sparging section 1603 may form a fraction of the distance between first end 1602 and second end 1606 (as shown), or it could be disposed along the entire length of the reactor.

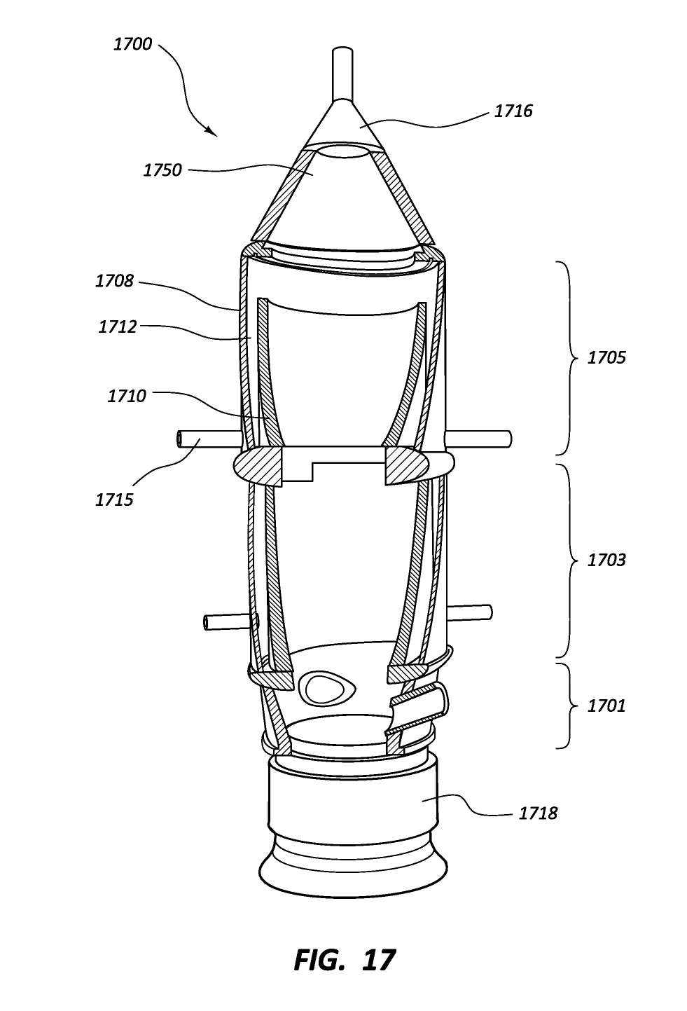

FIG. 17 illustrates another embodiment of a vortex reactor 1700 that may be utilized for hydrogen production. The embodiment of FIG. 17 includes a transition section 1701 and a sparging section 1703 and is similar to the embodiment of FIG. 16. The embodiment of FIG. 17 includes a upper section 1705 that includes an inner structure 1710 positioned to form an annular space 1712 between inner structure 1710 and outer wall 1708 of reactor 1700. A gas space 1750 is disposed above upper section 1705. Reactor 1700 may be configured so that the vortical fluid flow reaches just above inner structure 1710, so that fluid can fall into annular space 1712 to be removed by overflow fluid outlets 1715. The generated hydrogen gas and the sparging gas collects in gas space 1750, where it can exit through gas outlet 1716.

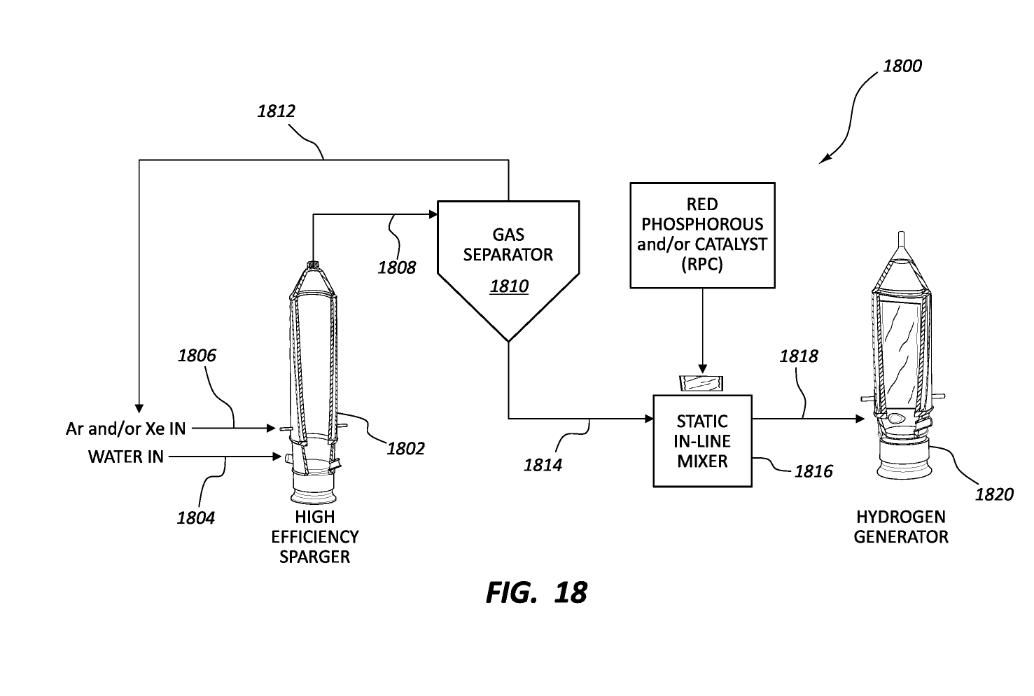

FIG. 18 illustrates an embodiment of a system 1800 for hydrogen production that utilizes at least two vortex reactor embodiments. A first vortex reactor 1802 is configured as a high-efficiency sparger, and may be similar to the embodiment illustrated in FIG. 14. First vortex reactor 1802 receives water 1804 and sparging gas 1806 (e.g., xenon and/or argon), and functions to provide a fluid having a high level of dissolved gases. The fluid with dissolved gas exits as stream 1808 and is routed to a gas separator 1810, where free gas 1812 (gas not dissolved in stream 1808) is separated and may optionally be recycled back to first vortex reactor 1802.

The fluid with dissolved gas exits gas separator 1810 as stream 1814, and is routed to a mixer 1816 (e.g., a static in-line ribbon mixer) to be blended with RPC. After mixing, the fluid is passed as stream 1818 to second vortex reactor 1820, where hydrogen generation is carried out. Second vortex reactor 1820 may be configured similar to the embodiments illustrated in FIGS. 16 and 17, though a sparging section may be omitted.

System 1800 advantageously provides dissolved gas to the water, using first vortex reactor 1802, to act as nuclei for cavitation bubble generation in second vortex reactor 1820. Second vortex reactor 1820 can then impart energy to the fluid (e.g., through ultrasound, synchrotron radiation, free-electron laser pulses) without interference from sparged bubbles or an overabundance of large sections of gas. Further, ultrasound energy is more effectively propounded through a liquid medium than a gas, and the reduction in volume taken up by gas in second vortex reactor 1820 therefore enables more effective use of ultrasound energy.

The terms “approximately,” “about,” and “substantially” as used herein represent an amount or condition close to the stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a stated amount or condition.

Elements described in relation to any embodiment depicted and/or described herein may be combinable with elements described in relation to any other embodiment depicted and/or described herein. For example, any element described in relation to a single vortex reactor embodiment and/or induction mechanism embodiment may be combinable with a double vortex reactor embodiment, excluding those elements necessary to distinguish single vortex reactors from dual vortex reactors.

1. A vortex reactor, comprising:
a reactor body having a first end and a second end;
a single inlet port, or a plurality of asymmetrically arranged inlet ports, disposed at the first end and configured to direct a fluid into the reactor body; and
an outlet configured to receive and pass the fluid out of the reactor body,
wherein the vortex reactor is configured to induce formation of at least one vortex within the fluid as the fluid is passed from the one or more inlet ports to the outlet in order to impart at least one physical or chemical effect to the fluid.

2. The vortex reactor of claim 1, wherein the outlet is disposed at the second end.

3. The vortex reactor of claim 1, further comprising an annular inner structure disposed within the reactor body, the inner structure defining an annular space between the inner structure and an outer wall of the reactor body, the inner structure being formed of a porous material to enable sparging of gas from the annular space into an interior of the reactor.

4. The vortex reactor of claim 3, wherein the inner structure is formed of a sintered metal material.

5. The vortex reactor of claim 1, further comprising an electrically conductive inner structure disposed within the reactor body and an electrically conductive outer shell wrapped at least partially around the reactor body, the electrically conductive inner structure defining an annular space between an outer wall of the reactor and the electrically conductive inner structure for receiving a portion of the vortically flowing fluid into the annular space.

6. The vortex reactor of claim 5, further comprising an annular space outlet for outputting the portion of the vortically flowing fluid received into the annular space.

7. The vortex reactor of claim 1, wherein the outlet is divided into a central line outlet configured to receive gas generated or flowing through the reactor and a plurality of fluid outlets radially disposed around the central line outlet.

8. The vortex reactor of claim 1, further comprising an energy-imparting device configured to impart energy to the fluid.

9. The vortex reactor of claim 8, wherein the energy-imparting device comprises an ultrasound transducer or an ultrasonic horn.

10. The vortex reactor of claim 9, wherein the ultrasound transducer or ultrasonic horn is positioned at the first end or second end of the reactor body.

11. The vortex reactor of claim 9, wherein the ultrasound transducer or ultrasonic horn is configured to operate within a frequency range of about 20 kHz to 3 MHz.

12. The vortex reactor of claim 8, wherein the energy-imparting device includes a waveform generator and an amplifier.

13. The vortex reactor of claim 8, wherein the energy-imparting device includes a first tactile sound transducer.

14. The vortex reactor of claim 13, further comprising a second tactile sound transducer, the first and second tactile sound transducers being disposed on opposite ends of the reactor body so as to enable the production of standing waves during operation of the reactor.

15. The vortex reactor of claim 14, further comprising a first transmitting plate coupled to the first tactile sound transducer and configured to transmit acoustic energy from the first tactile sound transducer into the reactor body.

16. The vortex reactor of claim 13, wherein the first tactile sound transducer is configured to operate at a frequency of about 5 Hz to 20 kHz, or about 20 Hz to 20 kHz, or about 1 kHz to 20 kHz, or about 5 kHz to 20 kHz, or about 7 kHz to 17 kHz, or about 12 kHz.

17. The vortex reactor of claim 1, further comprising a vortex induction mechanism disposed within the reactor body between the first and second ends and that is configured to induce vortical motion within the fluid as the fluid is directed across or through the induction mechanism.

18. The vortex reactor of claim 17, wherein the vortex induction mechanism includes a plurality of angled flights disposed on an exterior surface of the vortex induction mechanism, the vortex induction mechanism being positioned to direct passing fluid over the flights to induce vortical motion in the fluid.

19. The vortex reactor of claim 18, wherein the vortex induction mechanism is characterized by at least one of (i) a prolate spheroid, (ii) the plurality of angled flights forming a screw, or (ii) the plurality of angled flights of the vortex induction mechanism being configured to progressively increase the angular velocity of the fluid as the fluid passes across or through the vortex induction mechanism.

20. The vortex reactor of claim 17, further comprising an energy-imparting device configured as an axial probe extending from the first end into the reactor body, wherein the vortex induction mechanism includes a bore and at least a portion of the axial probe extends into the bore and beyond the vortex induction mechanism.

21. The vortex reactor of claim 20, wherein the axial probe includes a non-emitting section and an emitting section, the emitting section being disposed on the portion of the probe extending beyond the vortex induction mechanism.

22. The vortex reactor of claim 17, wherein the vortex induction mechanism includes an inner channel, an exterior induction structure disposed along at least a portion of an exterior surface of the vortex induction mechanism, and an interior induction structure disposed along at least a portion of a surface of the inner channel, the inner channel being in communication with a second inlet port to receive a second fluid into the inner channel.

23. The vortex reactor of claim 22, wherein the fluid is passed across the exterior induction structure and the second fluid is passed across the interior induction structure, and wherein the fluid and the second fluid meet and are mixed at a mixing zone disposed beyond the vortex induction mechanism.

24. The vortex reactor of claim 23, wherein the exterior induction structure and the interior induction structure are configured to induce the fluid and second fluid to rotate in opposite directions.

25. The vortex reactor of claim 23, further comprising an energy-imparting device arranged radially around the reactor body and configured to impart energy into the mixing zone.

26. The vortex reactor of claim 1, wherein the inlet port is configured to direct a fluid at an angle that is substantially tangential to an inner surface of the reactor body, thereby causing the fluid to flow in a vortex along the inner surface of the reactor body toward the second end.

27. The vortex reactor of claim 26, wherein the outlet is disposed at the first end or between the inlet and the second end, and wherein advancing the fluid into the reactor body through the inlet port causes the fluid to flow in an outer vortex along the inner surface of the reactor body a distance toward the second end before the fluid reverses axial direction to flow toward the outlet in an inner vortex.

28. The vortex reactor of claim 1, further comprising a bleed opening at the second end of the reactor body configured to allow passage of air or other gas.

29. The vortex reactor of claim 28, wherein the bleed opening is configured as a valve allowing one way passage of liquid or air or other gas or the bleed opening includes an attachment for coupling a gas line to the reactor body.

30. The vortex reactor of claim 1, further comprising a fluid within the reactor body and a volume of gas contained in a separate vessel and in fluid communication with the fluid.

31. The vortex reactor of claim 30, wherein the fluid within the reactor body is a non-compressible liquid.

32. The vortex reactor of claim 30, wherein the fluid within the reactor body comprises a hydrocarbon fuel, crude oil, wastewater, water, or seawater.

33. The vortex reactor of claim 1, wherein the reactor body is at least partially formed of a porous material configured to allow passage of one or more fluid components into and/or through the reactor wall in order to separate the one or more fluid components.

34. The vortex reactor of claim 33, further comprising means for applying a voltage across the porous material that enables the porous material to remove ions from fluid passing at least partially through the porous material.

35. The vortex reactor of claim 33, wherein the porous material comprises carbon aerogel.

36. The vortex reactor of claim 1, wherein the outlet is configured as a plurality of concentric sections, each concentric section being associated with a radial separation zone within the reactor.

37. The vortex reactor of claim 1, further comprising a solid object positioned along an axis of the reactor.

38. The vortex reactor of claim 1, further comprising a fluid collection tank in fluid communication with the outlet.

39. The vortex reactor of claim 38, wherein the outlet is in communication with an air space in the fluid collection tank.

40. The vortex reactor of claim 38, wherein the outlet is not in communication with an air space in the fluid collection tank so that there is continuous liquid between the outlet and the fluid collection tank.

41. The vortex reactor of claim 1, further comprising means for imparting ozone to a reactor fluid within the reactor body.

42. The vortex reactor of claim 41, wherein the means for imparting ozone to the reactor fluid comprises one or more Venturi injectors coupled to one or more inlet ports.

43. A vortex reactor system including a plurality of vortex reactors according to claim 1, the plurality of vortex reactors being arranged in series and/or in parallel.

44. The vortex reactor system of claim 43, further comprising one or more heat exchangers configured to exchange heat with an outlet fluid from one or more of the plurality of vortex reactors.

45. A vortex reactor, comprising:
a reactor body having a first end, a second end, and an inner surface;
one inlet port, or a plurality of inlet ports, disposed at the first end and configured to direct a fluid at an angle that is substantially tangential to the inner surface of the reactor body, at least one of the plurality of inlet ports being asymmetrically arranged with respect to at least one other inlet port; and
an outlet disposed at the first end and/or between the one or more inlet ports and the second end;
wherein advancing a fluid into the reactor body through the one or more inlet ports causes the fluid to flow in a vortex along the inner surface of the reactor body toward the second end.

46. A vortex reactor, comprising:
a reactor body having a first end, a second end, and an inner surface;
one or more inlet ports disposed at the first end and configured to direct a fluid at an angle that is substantially tangential to the inner surface of the reactor body; and
an outlet disposed at the first end and/or between the one or more inlet ports and the second end;
wherein advancing a fluid into the reactor body through the one or more inlet ports causes the fluid to flow in an outer vortex along the inner surface of the reactor body a distance toward the second end before the fluid reverses direction to flow toward the outlet in an inner vortex.

47. A method of processing a fluid in order to impart one or more physical and/or chemical effects to the fluid, the method comprising passing the fluid through a vortex reactor according to claim 1.

48. The method of claim 47, wherein the fluid is processed according to one or more of a hydrogen production, water clarification, cetane number boosting, biodiesel production, crude oil demulsifying, crude oil desalting, light cycle oil processing, sparging, waste sludge disintegration, desalination, mixing, destruction of pharmaceuticals in wastewater, or separating operation.
